(19) United States
(12) Patent Application Publication
(10) Pub. No.: US 2025/0260498 A1
(43) Pub. Date: Aug. 14, 2025

(54) CONFIGURING MARGINS FOR SINGLE ANTENNA REDUCED CAPABILITY USER EQUIPMENT

(71) Applicant: Intel Corporation, Santa Clara, CA (US)

(72) Inventors: RUI HUANG, Beijing (CN); IN-SEOK HWANG, Santa Clara, CA (US); HUA LI, Beijing (CN); MENG ZHANG, Beijing (CN)

(73) Assignee: Intel Corporation, Santa Clara, CA (US)

(21) Appl. No.: 18/849,293

(22) PCT Filed: Apr. 21, 2023
(86) PCT No.: PCT/US2023/019373

§ 371 Date: Sep. 20, 2024

Related U.S. Application Data
(60) Provisional application No. 63/333,980, filed on Apr. 22, 2022.
(60) Provisional application No. 63/394,913, filed on Aug. 3, 2022.

(51) Int. Cl. H04B 17/318; H04W 76/27

(52) U.S. Cl. CPC H04B 17/328; H04W 76/27

(57) ABSTRACT

Embodiments attempt to solve challenges in a wireless communications system. Embodiments describe various techniques, systems, and devices to support relaxed measurement criteria for reduced capability devices in a 3GPP 5G NR system, among other wireless communications systems. Other embodiments are described and claimed.

This application claims the benefit of and priority to previously filed U.S. Provisional Patent Application Ser. No. 63/394,913, filed Aug. 3, 2022, entitled “CONFIGURING MARGINS FOR SINGLE ANTENNA REDUCED CAPABILITY UES”, and U.S. Provisional Patent Application Ser. No. 63/333,980, filed Apr. 22, 2022, entitled “TRANSMITTING SMALL DATA PACKETS FOR REDUCED CAPABILITY USER EQUIPMENTS (UES)”, both of which are hereby incorporated by reference in their entireties.

### BACKGROUND

Wireless communication systems are rapidly growing in usage. Further, wireless communication technology has evolved from voice-only communications to also include the transmission of data, such as Internet and multimedia content, to a variety of devices. To accommodate a growing number of devices communicating, many wireless communication systems share the available communication channel resources among devices. Further, Internet-of-Thing (IoT) devices are also growing in usage and can coexist with user devices in various wireless communication systems such as cellular networks.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless communication system in accordance with one embodiment.

FIG. 2A illustrates an operating environment in accordance with one embodiment.

FIG. 2B illustrates an operating environment in accordance with one embodiment.

FIG. 2C illustrates an operating environment in accordance with one embodiment.

FIG. 3 illustrates apparatus for a user equipment (UE) in accordance with one embodiment.

FIG. 4 illustrates a data schema for measurement information in accordance with one embodiment.

FIG. 5 illustrates a logic flow in accordance with one embodiment.

FIG. 6 illustrates a media access control (MAC) entity in accordance with one embodiment.

FIG. 7 illustrates a logic flow in accordance with one embodiment.

FIG. 8 illustrates a logic flow in accordance with one embodiment.

FIG. 9 illustrates a logic flow in accordance with one embodiment.

FIG. 10 illustrates a first network in accordance with one embodiment.

FIG. 11 illustrates a second network in accordance with one embodiment.

FIG. 12 illustrates a third network in accordance with one embodiment.

FIG. 13 illustrates a computer readable storage medium in accordance with one embodiment.

### DETAILED DESCRIPTION

Embodiments are generally directed to wireless communication systems. Some embodiments are particularly directed to managing how to share available communication channel resources among devices for a wireless communication system. Sharing radio resources in a wireless communications system includes a set of management operations sometimes referred to as radio resource management (RRM). The embodiments may implement techniques to improve RRM for different classes of devices in an efficient and effective manner.

Embodiments attempt to improve RRM in a Third Generation Partnership Project (3GPP) system, such as a fifth generation new radio (5G NR) cellular system. For example, a 5G NR cellular system may support different classes of devices, such as a standard class of devices and a reduced capability (RedCap) class of devices. Each class may have a different set of capabilities, resources, requirements and measurement rules to manage radio resources for the 5G NR cellular system. Generally, a standard class of devices has a set of standard RRM requirements and measurement rules (referred to as “standard measurement criterion” or “standard measurement criteria”), and a RedCap class has a set of relaxed RRM requirements and measurement rules relative to the standard class (referred to as “relaxed measurement criterion” or “relaxed measurement criteria”). In some cases, the relaxed measurement criteria may also be applied to standard devices, such as RRM measurements in low mobility and edge scenarios. Consequently, there is a need for a 3GPP system to efficiently apply a set of standard measurement criteria or a set of relaxed measurement criteria for different types of devices implementing radio resources, such as user equipment (UE) and/or base station. Accordingly, embodiments define a new set of techniques and optimizations to improve RRM in a wireless communication system, such as a 5G NR cellular system, that supports multiple classes of devices. It may be appreciated that embodiments can be implemented for other cellular systems as well. Embodiments are not limited in this context.

In many wireless communication systems, including long-term evolution (LTE) and fifth generation new radio (5G NR) cellular networks, a user equipment (UE) transmits data to a base station (BS) over a radio using various radio resources. As such, radio resource management (RRM) is a crucial component of a radio access network (RAN), such as RAN in Third Generation Partnership Project (3GPP) systems, including both Long-Term Evolution (LTE) and 5G NR cellular networks. RRM manages the allocation and coordination of the radio resources, including frequency, power, and time slots, among different users and services in the network. The primary goal of RRM is to ensure efficient and reliable use of radio resources while maintaining the quality of service (QoS) for all users. Some of the key functions of RRM in 3GPP systems include radio resource allocation, congestion control, handover management, scheduling, and power control. RRM also plays a critical role in managing interference and optimizing network capacity and coverage. Overall, RRM helps ensure the efficient and effective operation of wireless networks.

Various 3GPP documents define RRM for a 5G NR system, including 3GPP Technical Standards (TS), Technical Reports (TR) and/or Work Items (WI). Various embodiments discussed herein may be implemented in a wireless communications system as defined by the 3GPP TS 38.133 titled “Technical Specification Group Radio Access Network; NR; Requirements for support of radio resource management,” Release 17, particularly versions 17.0.0 (April 2020) to 17.8.0 (December 2022), and including current versions (version 17.9.0, January 2023), future versions, revisions or variants (collectively referred to as “3GPP TS 38.133 Standards”). The 3GPP TS 38.133 specifies requirements for support of RRM for the frequency division duplexing (FDD) and time division duplexing (TDD) modes of NR. These requirements include requirements on measurements in NR and the UE as well as requirements on node dynamical behavior and interaction, in terms of delay and response characteristics. Various embodiments discussed herein may be implemented in a wireless communications system as defined by the 3GPP TS 38.304 titled “NR; User Equipment (UE) procedures in idle mode,” Release 17, particularly versions 17.0.0 (April 2020) to 17.4.0 (April 2023), and including future versions, revisions or variants (collectively referred to as “3GPP TS 38.304 Standards”). Various embodiments discussed herein may be implemented in a wireless communications system as defined by the 3GPP TS 38.331 titled “NR; Radio Resource Control (RRC); Protocol specification,” Release 17, particularly versions 17.0.0 (April 2020) to 17.4.0 (March 2023), and including future versions, revisions or variants (collectively referred to as “3GPP TS 38.331 Standards”). Various embodiments discussed herein may be implemented in a wireless communications system as defined by the 3GPP TS 38.300 titled “NR; NR and NG-RAN Overall Description.” Release 17. particularly versions 17.0.0 (April 2020) to 17.4.0 (March 2023), and including future versions, revisions or variants (collectively referred to as “3GPP TS 38.300 Standards”). It may be appreciated that the embodiments may be implemented in accordance with other 3GPP TS and TR, as well as other wireless standards released by other standards entities. Embodiments are not limited in this context.

In a 5G NR system, such as defined by the 3GPP TS 38.133 Standards, a UE may initially power on and select a public land mobile network (PLMN). Once a PLMN is selected, a cell selection process takes place, as described in the 3GPP TS 38.304 Standards. This process allows the UE to select a suitable cell where to camp on in order to access available services. In this process, the UE can use stored information (e.g., Stored information cell selection) or not (e.g., Initial cell selection). The cell re-selection procedure allows the UE to select a more suitable cell and camp on it. When the UE is in either a Camped Normally state or a Camped on Any Cell state on a cell, the UE attempts to detect, synchronize, and monitor intra-frequency, inter-frequency and inter-radio access technology (RAT) cells indicated by a serving cell. For intra-frequency and inter-frequency cells the serving cell may not provide explicit neighbor list but carrier frequency information and bandwidth information only. UE measurement activity is also controlled by measurement rules defined in 3GPP TS 38.304 Standards, allowing the UE to limit its measurement activity.

In 5G NR Release 17. 3GPP introduced a new tier of reduced capability (RedCap) devices and supporting platform, also known as NR-Light. NR-Light is a new device platform that bridges the capability and complexity gap between the extremes in 5G today with an optimized design for mid-tier use cases. When compared to 5G enhanced mobile broadband (eMBB) devices that can support gigabits per second of throughput in the downlink and uplink, NR-Light devices can efficiently support 150 megabits per second (Mbps) and 50 Mbps in the downlink and uplink, respectively, due to a set of designed optimizations, such as: (1) 20 megahertz (MHz) in sub-6 gigahertz (GHz) or 100 MHz in millimeter wave (mmWave) frequency bands; (2) a single transmit (Tx) antenna (1 Tx); (3) a single receive (Rx) antenna (1 Rx), with 2 antennas (2 Rx) being optional; (4) optional support for half-duplex FDD; (5) lower-order modulation, with 256-quadrature amplitude modulation (QAM) being optional; and (6) support for lower transmit power. The reduced complexity contributes to more cost-efficient NR-Light devices, longer battery life due to lower power consumption, and a smaller device footprint, which enables newer designs for a broad range of use cases.

Some examples of use cases suitable for RedCap devices include video surveillance, industrial wireless sensors and wearable computers. Such use cases may need RedCap devices with less complex designs, such as a reduced number of UE transmit and receive antennas relative to a standard UE. For instance, a standard UE may have 2 Rx or 4 Rx antennas, while a RedCap UE may have 1 Rx or 2 Rx antennas. To further reduce complexity, RedCap devices may implement modified procedures for half-duplex frequency division duplex (HD-FDD), UE bandwidth reduction, relaxed UE processing time, and relaxed UE processing capability.

The 3GPP TS 38.133 Standards include a set of relaxed RRM requirements and measurement rules that may be applied to both standard devices and for RedCap devices. The relaxed RRM requirements and measurement rules may include relaxed measurement criteria for measurement thresholds of reference signals transmitted and received within a 3GPP system. However, the measurement thresholds are typically defined for a UE with multiple antennas and not a RedCap UE implementing a 1 Rx antenna. Consequently, the 3GPP TS 38.133 Standards may need certain modifications to define measurement thresholds suitable for a 1 Rx RedCap UE. More particularly, the 3GPP TS 38.133 Standards may need to be modified to define a new set of measurement thresholds that include a 1 Rx offset for a 1 Rx RedCap UE.

Accordingly, various embodiments define a new set of measurement thresholds suitable for inclusion in relaxed measurement criteria for RedCap UE as defined in one or more 3GPP standards, including 3GPP TS 38.133 Standards, for example. The new set of measurement thresholds may include, for example, a 1 Rx offset to define measurement thresholds (THLDs) for a RedCap UE having a single 1 Rx antenna. The 1 Rx offset may be added to different relaxed measurement criteria for various relaxation rules as defined by 3GPP. In a first example, a UE may have relaxed measurement criteria such as relaxing a required time for neighbor cell measurement when a UE is in different radio resource control (RRC) states. In a second example, a UE may have relaxed measurement criteria such as relaxing a required time to monitor for beam failure detection (BFD) reference signals of a serving cell. In a third example, a UE may have relaxed measurement criteria such as relaxing a required time to monitor for radio link management (RLM) reference signals of a serving cell. These are merely a few examples of relaxed measurement criteria, and others exist as well.

In some cases, rather than relaxed measurement criteria, various embodiments may also define a new set of measurement thresholds suitable for inclusion in more strict or conservative measurement criteria for RedCap UE. One motivation of 1 Rx offset is to configure more conservative setting for RRM operation. For instance, in a relaxed measurement use case, a RedCap UE may have a smaller RSRP Change TLHD than a standard UE for low mobility decisions, and a higher RSPP value than a standard UE for not-cell-edge decisions. However, more conservative THLDs may be used for small data transmission (SDT) transmissions, such as a smaller RSRP change THLD than a standard UE, or a higher RSRP THLD than a standard UE. These are merely a few examples of more conservative measurement criteria, and others exist as well.

In the first example, a UE may have relaxed measurement criteria such as relaxing a required time for neighbor cell measurement when a UE is in different RRC states. A UE can enter different RRC states, such as an idle state (RRC_IDLE) and a connected state (RRC_CONNECTED). The UE can also enter an inactive state (RRC_INACTIVE) where the UE is registered with the network but not actively transmitting data. A resume procedure can prepare a UE for subsequent data transmission by causing the UE to switch from an inactive state to a connected state. In 5G NR, the RRC states for a 5G NR enabled UE can include RRC IDLE, RRC_INACTIVE, and RRC_CONNECTED states. When not transmitting data in an RRC_CONNECTED state, the UE can switch to an RRC_INACTIVE state but remain registered with the network. RRM relaxation may be applicable to when a UE is in an RRC_IDLE state or an RRC_INACTIVE state. The 3GPP TS 38.133 standard introduces UE power saving by relaxing a required time for neighbor cell measurement when the UE is in an RRC_IDLE state or an RRC_INACTIVE state. In an RRC_IDLE or RRC_INACTIVE state, for example, the relaxed measurement may be for neighbor cell measurement. The decision whether to apply the relaxed measurement is made by comparing serving cell measurement results with a related relaxation THLD value.

In the second example, a UE may have relaxed measurement criteria such as relaxing a required time to monitor for BFD reference signals of a serving cell. BFD is a mechanism used in millimeter-wave (mmWave) communication to detect and mitigate the effects of beam misalignment or blockage. The detection can be done using various techniques, such as measuring the signal strength or phase of the received signal, or monitoring the feedback from the transmitter. The 3GPP TS 38.133 Standards introduce UE power saving by relaxing a required time for monitoring BFD reference signals of a serving cell when the UE is in an RRC_CONNECTED state.

In a third example, a UE may have relaxed measurement criteria such as relaxing a required time to monitor for radio link management (RLM) reference signals of a serving cell. RLM is a set of procedures used to manage the radio link between a UE and the base station (e.g., a NodeB or eNodeB) in a cellular network. The RLM procedures in 3GPP are specified in the radio resource control (RRC) protocol. The RRC protocol defines various parameters and measurements used by RLM, such as the Received Signal Strength Indicator (RSSI), the Reference Signal Received Quality (RSRQ), and the Reference Signal Received Power (RSRP). These measurements are used by the UE to evaluate the quality of the radio link and to determine the appropriate transmission parameters. The 3GPP TS 38.133 Standards introduce UE power saving by relaxing a required time for monitoring RLM reference signals of a serving cell when the UE is in an RRC_CONNECTED state. This can be implemented by modifying a 1 Rx measurement THLD using the 1 Rx offset to RRM relaxation criteria for a 1 Rx RedCap UE.

In addition to relaxed measurement criteria, a UE may have more conservative measurement criteria for small data transmission (SDT). In many wireless communication systems, including LTE and 5G NR cellular networks, a UE may need to transmit a small amount of data to a base station within the network. This is referred to as a small data transmission (SDT). For example, in a Cellular Internet of Things (CIoT), a sensor device equipped with a communication device such as a user equipment (UE) can take a sensor reading and then transmit the reading, or a batch of readings, to the BS. Other examples include tracking devices for Mobile Originated (MO) and Mobile Terminated (MT) use cases that report positions via the base station. The present disclosure describes, among other things, signaling mechanisms to support frequent small data transmission with and without path switching between different base stations. The 3GPP TS 38.133 Standards and/or the 3GPP TS 38.300 Standards may modify a 1 Rx measurement THLD using the 1 Rx offset to RRM conservative measurement criteria for a 1 Rx RedCap UE. For instance, more conservative THLDs may be used for SDT transmissions, such as a smaller RSRP change THLD than a standard UE. A smaller RSRP change THLD may be implemented by subtracting a 1.0 dB offset in a low mobility decision for “RRM relaxation” or “SDT transmission.” In another example, a 1 Rx RedCap UE may use a higher RSRP THLD than a standard UE. A higher RSRP THLD may be implemented by adding 1.0 dB offset for a no-cell edge decision for “RRM relaxation” or “SDT transmission.”

Embodiments generally define a new set of techniques and optimizations to improve RRM in a wireless communication system, such as a 5G NR cellular system in compliance with 3GPP TS 38.133 Standards, 3GPP 38.304 Standards, 3GPP 38.331 Standards, and/or 3GPP 38.300 Standards. More particularly, embodiments define a new set of techniques and optimizations to improve RRM in a 5G NR cellular system that supports multiple classes of devices. Some embodiments particularly define techniques and optimizations to efficiently configure a RedCap device with relaxed measurement criteria for reference signals received from base stations of one or more intra-frequency NR cells, inter-frequency NR cells, or inter-radio access technology (RAT) evolved universal terrestrial radio access network (E-UTRAN) cells. This may improve measurement accuracy for measurements made by or for a RedCap UE. For example, measurement accuracy may improve for synchronization signal based reference signal received power (SS-RSRP) measurements, synchronization signal based reference signal received quality (SS-RSRQ) measurements, or other measurements made by or for a RedCap UE in a 3GPP system. This can be implemented by modifying a 1 Rx measurement THLD using the 1 Rx offset to RRM relaxation criteria for a 1 Rx RedCap UE.

In one example of RedCap, a standard device may be a UE having 2 Rx or 4 Rx antenna, while a RedCap device may comprise a UE having a 1 Rx or 2 Rx antenna. In various embodiments, the 1 Rx offset may be implemented for a 1 Rx RedCap UE. A RedCap UE having 1 Rx antenna may have a SS-RSRP or SS-RSRQ measurement accuracy that is relatively worse than a standard UE having a 2 Rx antenna. Consequently, it is necessary to efficiently configure relaxed measurement criteria, such as offsets (margins) for evaluation thresholds, for the RedCap UE having a 1 Rx antenna relative to the standard measurement criteria for evaluation thresholds for the standard UE having a 2 Rx or 4 Rx antenna.

Accordingly, embodiments propose an efficient and effective technique to configure relaxed measurement criteria for RedCap devices to improve RRM for a 5G NR system. In one embodiment, for example, an apparatus for UE may include a memory interface to send or receive, to or from a data storage device, measurement information for a 5G NR system. The apparatus may also include processor circuitry communicatively coupled to the memory interface, the processor circuitry to decode measurements of a reference signal received from a base station of a cell by UE with reduced capability (RedCap) to obtain a measurement value, retrieve a relaxed measurement criterion for RedCap associated with the UE with RedCap, and evaluate the measurement value in accordance with the relaxed measurement criterion for RedCap to obtain a measurement result. In one embodiment, for example, the RedCap UE may comprise a 1 Rx RedCap UE, and the relaxed measurement criterion may comprise a 1 Rx measurement THLD using a 1 Rx offset for the 1 Rx RedCap UE. The processor circuitry may determine whether to select the base station of the cell as a serving cell for the UE with RedCap based on the measurement result. Additionally, or alternatively, the processor circuitry may determine whether to search for a base station of a neighbor cell of the cell as a serving cell for the UE with RedCap based on the measurement result. Other technical features may be readily apparent to one skilled in the art from the following figures, descriptions, and claims.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

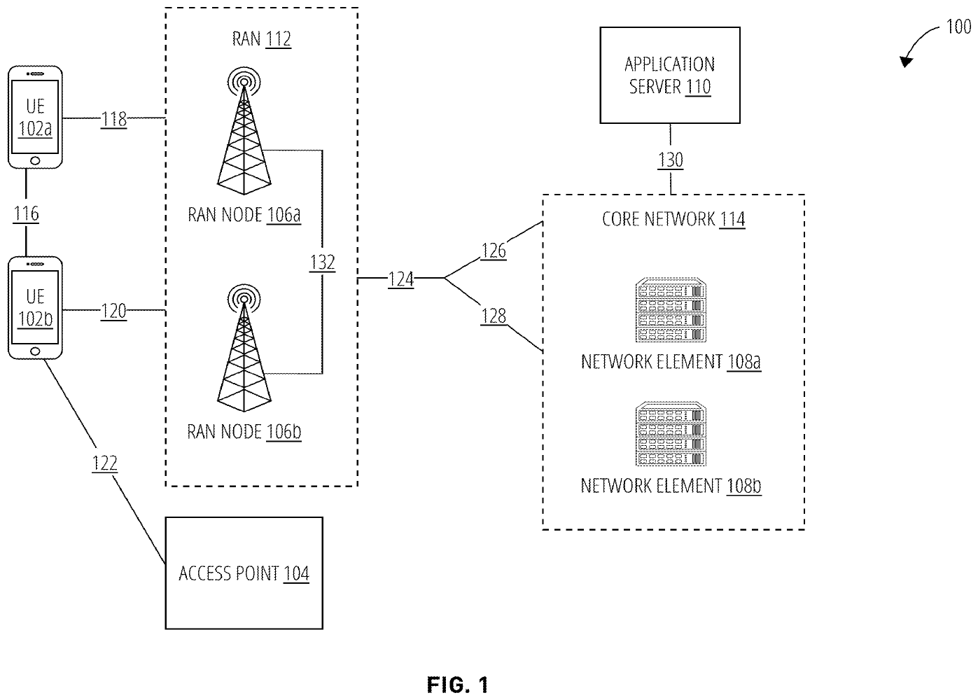

FIG. 1 illustrates an example of a wireless communication wireless communications system 100. For purposes of convenience and without limitation, the example wireless communications system 100 is described in the context of the long-term evolution (LTE) and fifth generation (5G) new radio (NR) (5G NR) cellular networks communication standards as defined by one or more 3GPP TS 38.133 Standards, 3GPP TS 38.304 Standards, 3GPP 38.331 Standards, or 3GPP 38.300 Standards, or other 3GPP standards or specifications. However, other types of wireless standards are possible as well.

The wireless communications system 100 supports two classes of UE devices, including a reduced capability (RedCap) UE 102a and standard UE 102b (collectively referred to as the “UEs 102”). In one embodiment, the RedCap UE 102a may have a set of one or more reduced capabilities relative to a set of standard capabilities of the standard UE 102b. Examples of reduced capabilities may include without limitation: (1) 20 megahertz (MHz) in a sub-6 or sub-7 gigahertz (GHz) or 100 MHz in millimeter wave (mmWave) frequency bands; (2) a single transmit (Tx) antenna (1 Tx); (3) a single receive (Rx) antenna (1 Rx), with 2 antennas (2 Rx) being optional; (4) optional support for half-duplex FDD; (5) lower-order modulation, with 256-quadrature amplitude modulation (QAM) being optional; and (6) support for lower transmit power. In one embodiment, for example, the standard UE 102b may have a 2 Rx or 4 Rx antenna, while the RedCap UE 102a may only have a 1 Rx antenna. The RedCap UE 102a may have other reduced capabilities as well. Embodiments are not limited in this context.

In this example, the UEs 102 are illustrated as smartphones (e.g., handheld touchscreen mobile computing devices connectable to one or more cellular networks). In other examples, any of the UEs 102 can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices. Internet of Things (IOT) devices, or combinations of them, among others.

In some implementations, any of the UEs 102 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 102 are configured to connect (e.g., communicatively couple) with a radio access network (RAN) 112. In some implementations, the RAN 112 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 112 that operates in a 5G NR wireless communications system 100, and the term “E-UTRAN” may refer to a RAN 112 that operates in an LTE or 4G wireless communications system 100.

To connect to the RAN 112, the UEs 102 utilize connections (or channels) 118 and 120, respectively, each of which can include a physical communications interface or layer, as described below. In this example, the connections 118 and 120 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 102b is shown to be configured to access an access point (AP) 104 (also referred to as “WLAN node 104,” “WLAN 104,” “WLAN Termination 104,” “WT 104” or the like) using a connection 122. The connection 122 can include a local wireless connection, such as a connection consistent with any IEEE 802.11 protocol, in which the AP 104 would include a wireless fidelity (Wi-Fi) router. In this example, the AP 104 is shown to be connected to the Internet without connecting to the core network of the wireless system, as described in further detail below.

The RAN 112 can include one or more nodes such as RAN nodes 106a and 106b (collectively referred to as “RAN nodes 106” or “RAN node 106”) that enable the connections 118 and 120. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 106 that operates in an 5G NR wireless communications system 100 (for example, a gNB), and the term “E-UTRAN node” may refer to a RAN node 106 that operates in an LTE or 4G wireless communications system 100 (e.g., an eNB). In some implementations, the RAN nodes 106 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 1). In some implementations, the gNB-DUs can include one or more remote radio heads or RFEMs, and the gNB-CU may be operated by a server that is located in the RAN 112 (not shown) or by a server pool in a similar manner as the CRAN/vBBUP. Additionally, or alternatively, one or more of the RAN nodes 106 may be next generation eNBs (ng-eNBs), including RAN nodes that provide E-UTRA user plane and control plane protocol terminations toward the UEs 102, and are connected to a 5G core network (e.g., core network 114) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 102 (vUEs 102). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the UEs 102. In some implementations, any of the RAN nodes 106 can fulfill various logical functions for the RAN 112 including, but not limited to, radio network controller (RNC) functions such as radio bearer management, uplink and downlink dynamic radio resource management and data packet scheduling, and mobility management.

In some implementations, the UEs 102 can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the UEs 102 over various channels. Various examples of downlink communication channels include Physical Broadcast Channel (PBCH), Physical Downlink Control Channel (PDCCH), and Physical Downlink Shared Channel (PDSCH). Other types of downlink channels are possible. The UEs 102 can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the UEs 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the UEs 102. The PDCCH carries information about the transport format and resource allocations related to the PDSCH channel, among other things. It may also inform the UEs 102 about the transport format, resource allocation, and hybrid automatic repeat request (HARQ) information related to the uplink shared channel. Downlink scheduling (e.g., assigning control and shared channel resource blocks to the UE 102b within a cell) may be performed at any of the RAN nodes 106 based on channel quality information fed back from any of the UEs 102. The downlink resource assignment information may be sent on the PDCCH used for (e.g., assigned to) each of the UEs 102.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 132. In examples, such as where the wireless communications system 100 is an LTE system (e.g., when the core network 114 is an evolved packet core (EPC) network), the interface 132 may be an X2 interface 132. The X2 interface may be defined between two or more RAN nodes 106 (e.g., two or more eNBs and the like) that connect to the EPC 114, or between two eNBs connecting to EPC 114, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 102 from a secondary eNB for user data; information of PDCP PDUs that were not delivered to a UE 102; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionalities.

In some implementations, such as where the wireless communications system 100 is a 5G NR system (e.g., when the core network 114 is a 5G core network), the interface 132 may be an Xn interface 132. The Xn interface may be defined between two or more RAN nodes 106 (e.g., two or more gNBs and the like) that connect to the 5G core network 114, between a RAN node 106 (e.g., a gNB) connecting to the 5G core network 114 and an eNB, or between two eNBs connecting to the 5G core network 114, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN nodes 106, among other functionalities. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 112 is shown to be communicatively coupled to a core network 114 (referred to as a “CN 114”). The CN 114 includes multiple network elements, such as network element 108a and network element 108b (collectively referred to as the “network elements 108”), which are configured to offer various data and telecommunications services to customers/subscribers (e.g., users of UEs 102) who are connected to the CN 114 using the RAN 112. The components of the CN 114 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 114 may be referred to as a network slice, and a logical instantiation of a portion of the CN 114 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 110 may be an element offering applications that use IP bearer resources with the core network (e.g., UMTS packet services (PS) domain, LTE PS data services, among others). The application server 110 can also be configured to support one or more communication services (e.g., VoIP sessions, PTT sessions, group communication sessions, social networking services, among others) for the UEs 102 using the CN 114. The application server 110 can use an IP communications interface 130 to communicate with one or more network elements 108a.

In some implementations, the CN 114 may be a 5G core network (referred to as “5GC 114” or “5G core network 114”), and the RAN 112 may be connected with the CN 114 using a next generation interface 124. In some implementations, the next generation interface 124 may be split into two parts, a next generation user plane (NG-U) interface 114, which carries traffic data between the RAN nodes 106 and a user plane function (UPF), and the S1 control plane (NG-C) interface 126, which is a signaling interface between the RAN nodes 106 and access and mobility management functions (AMFs). Examples where the CN 114 is a 5G core network are discussed in more detail with regard to later figures.

In some implementations, the CN 114 may be an EPC (referred to as “EPC 114” or the like), and the RAN 112 may be connected with the CN 114 using an S1 interface 124. In some implementations, the S1 interface 124 may be split into two parts, an S1 user plane (S1-U) interface 128, which carries traffic data between the RAN nodes 106 and the serving gateway (S-GW), and the S1-MME interface 126, which is a signaling interface between the RAN nodes 106 and mobility management entities (MMEs).

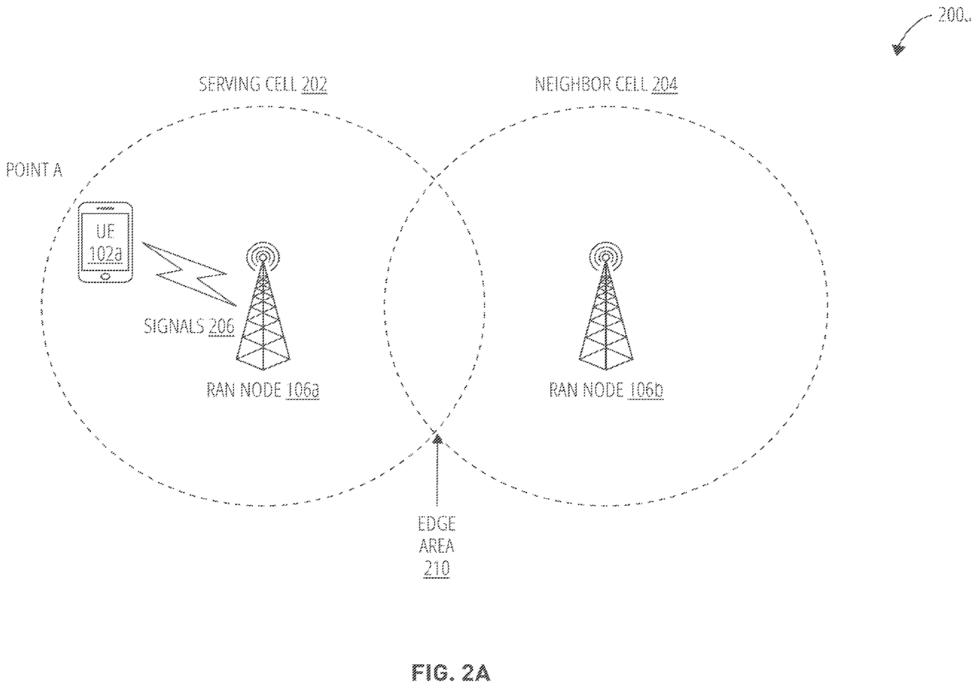

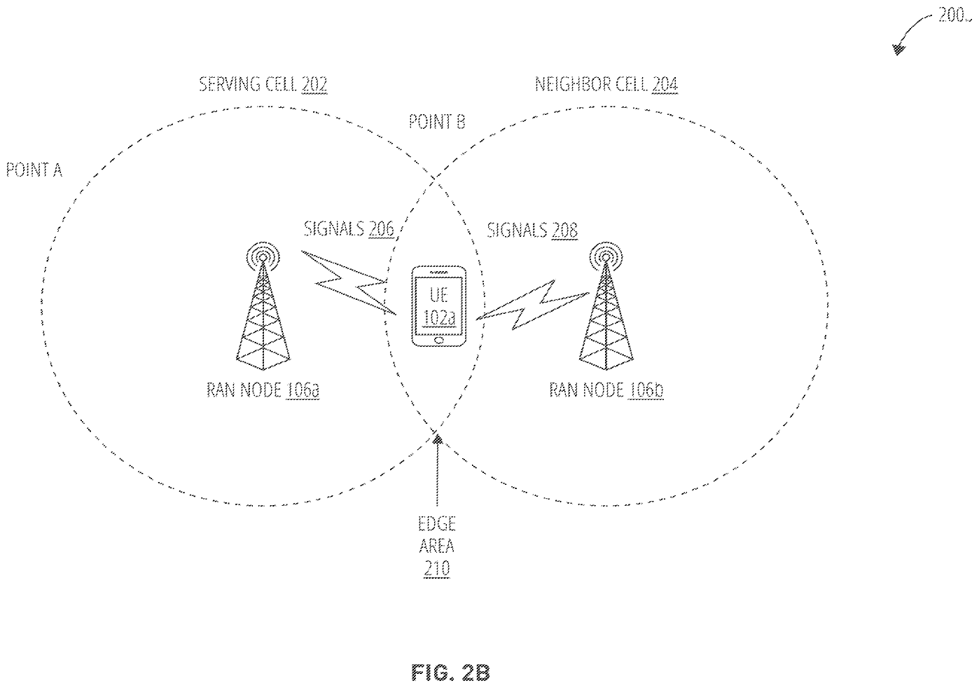

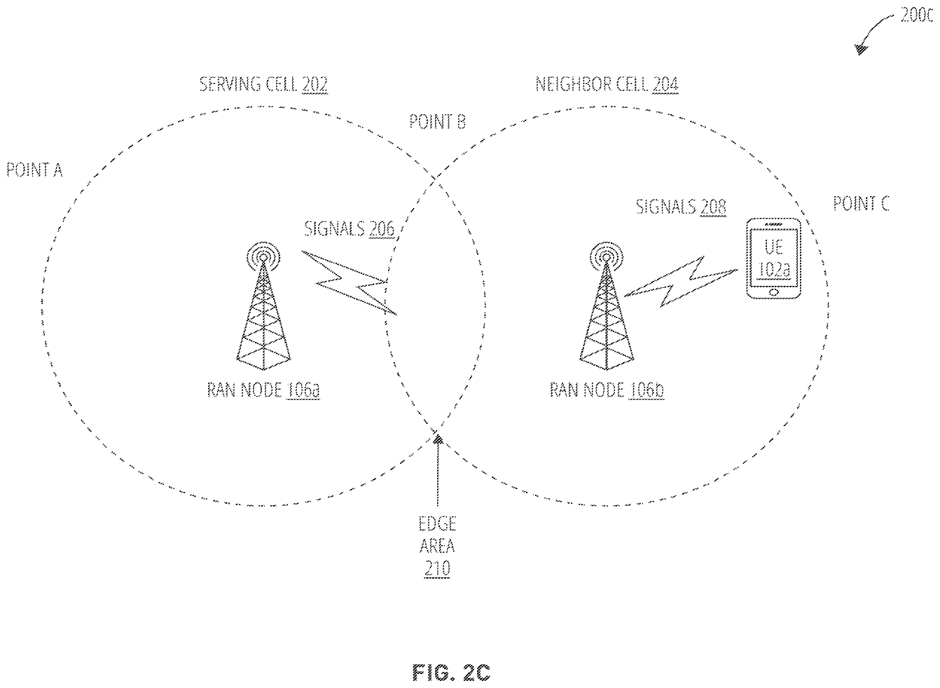

FIG. 2A illustrates an operating environment 200a. The operating environment 200a depicts the RedCap UE 102a of the wireless communications system 100 in wireless communication with the RAN node 106a via signals 206 in a serving cell 202. The operating environment 200a also depicts the RAN node 106b in a neighbor cell 204 of the serving cell 202. The RAN node 106a and the RAN node 106b may have radio transceivers with sufficient transmit power to form overlapping transmission envelopes creating an edge area 210.

As previously discussed, embodiments generally define a new set of techniques and optimizations to improve RRM in a wireless communication system, such as a wireless communications system 100, which is a 5G NR cellular system in compliance with 3GPP TS 38.133 Standards, 3GPP 38.304 Standards and/or 3GPP 38.331 Standards. More particularly, embodiments define a new set of techniques and optimizations to improve RRM in a 5G NR cellular system that supports multiple classes of devices. Some embodiments particularly define techniques and optimizations to efficiently configure a RedCap device, such as RedCap UE 102a, with relaxed measurement criteria for reference signals 206 received from base stations (e.g., RAN node 106a or RAN node 106b) of one or more cells (e.g., serving cell 202 or neighbor cell 204). In various embodiments, the cells can be implemented as intra-frequency NR cells, inter-frequency NR cells, or inter-radio access technology (RAT) evolved universal terrestrial radio access network (E-UTRAN) cells. This may improve measurement accuracy for measurements made by or for a RedCap UE 102a, the RAN node 106a, the RAN node 106b, or a combination thereof. For example, measurement accuracy may improve for the signals 206 and/or the signals 208, such as synchronization signal based reference signal received power (SS-RSRP) measurements, synchronization signal based reference signal received quality (SS-RSRQ) measurements, RLM measurements, BFD measurements, SDT measurements, or other measurements made by or for a RedCap UE 102a in a 3GPP system.

In operation, assume the RedCap UE 102a is a mobile device currently positioned at point A. The RedCap UE 102a may initially power on and select a public land mobile network (PLMN). Once a PLMN is selected, a cell selection process takes place, as described in the 3GPP TS 38.304 Standards. This process allows the RedCap UE 102a to select a suitable cell where to camp on in order to access available services, such as the serving cell 202. In this process, the RedCap UE 102a can use stored information (e.g., Stored information cell selection) or not (e.g., Initial cell selection). In either case, the RedCap UE 102a attempts to detect, synchronize, and monitor intra-frequency, inter-frequency and inter-radio access technology (RAT) cells indicated by the serving cell 202. For intra-frequency and inter-frequency cells the serving cell 202 may not provide explicit neighbor list but carrier frequency information and bandwidth information only. The RedCap UE 102a measurement activity is also controlled by measurement rules defined in the 3GPP TS 38.133 Standards, the 3GPP TS 38.304 Standards, the 3GPP TS 38.331 Standards, and/or the 3GPP TS 38.300 Standards, allowing the RedCap UE 102a to limit its measurement activity in accordance with a set of relaxed measurement criteria defined by the various 3GPP standards.

The relaxed measurement criteria may define measurement thresholds of reference signals transmitted and received within a 3GPP system, such as the signals 206 communicated between the RedCap UE 102a and the RAN node 106a. This can be implemented by modifying a 1 Rx measurement THLD using the I Rx offset to RRM relaxation criteria for a 1 Rx RedCap UE. In a first example, the RedCap UE 102a may have relaxed measurement criteria such as relaxing a required time for neighbor cell measurement when a UE is in different radio resource control (RRC) states. In a second example, the RedCap UE 102a may have relaxed measurement criteria such as relaxing a required time to monitor for beam failure detection (BFD) reference signals of a serving cell. In a third example, the RedCap UE 102a may have relaxed measurement criteria such as relaxing a required time to monitor for radio link management (RLM) reference signals of a serving cell. These are merely a few examples of relaxed measurement criteria, and others exist as well.

In the first example, the RedCap UE 102a may have relaxed measurement criteria such as relaxing a required time for neighbor cell measurement when a UE is in different RRC states. The RedCap UE 102a can enter different RRC states, such as an idle state (RRC_IDLE) and a connected state (RRC_CONNECTED). The RedCap UE 102a can also enter an inactive state (RRC_INACTIVE) where the RedCap UE 102a is registered with the network but not actively transmitting data. A resume procedure can prepare the RedCap UE 102a for subsequent data transmission by causing the RedCap UE 102a to switch from an inactive state to a connected state. In 5G NR, the RRC states for a 5G NR enabled UE such as the RedCap UE 102a can include RRC IDLE, RRC_INACTIVE, and RRC_CONNECTED states. When not transmitting data in an RRC_CONNECTED state, the RedCap UE 102a can switch to an RRC_INACTIVE state but remain registered with the network. The relaxed measurement criteria may be applicable to when a UE is in an RRC_IDLE state or an RRC_INACTIVE state. The 3GPP TS 38.133 Standards introduce RedCap UE 102a power saving by relaxing a required time for neighbor cell measurement when the RedCap UE 102a is in an RRC_IDLE state or an RRC_INACTIVE state. This can be implemented by modifying a 1 Rx measurement THLD using the 1 Rx offset to RRM relaxation criteria for a 1 Rx RedCap UE.

In the second example, the RedCap UE 102a may have relaxed measurement criteria such as relaxing a required time to monitor for BFD reference signals of a serving cell. BFD is a mechanism used in millimeter-wave (mmWave) communication to detect and mitigate the effects of beam misalignment or blockage. The detection can be done using various techniques, such as measuring the signal strength or phase of the received signal, or monitoring the feedback from the transmitter. The 3GPP TS 38.133 Standards introduce the RedCap UE 102a power saving by relaxing a required time for monitoring BFD reference signals of a serving cell when the RedCap UE 102a is in an RRC_CONNECTED state. This can be implemented by modifying a 1 Rx measurement THLD using the 1 Rx offset to RRM relaxation criteria for a 1 Rx RedCap UE.

In a third example, the RedCap UE 102a may have relaxed measurement criteria such as relaxing a required time to monitor for radio link management (RLM) reference signals of a serving cell. RLM is a set of procedures used to manage the radio link between the RedCap UE 102a and a base station (e.g., a NodeB or eNodeB) in a cellular network. The RLM procedures in 3GPPare specified in the radio resource control (RRC) protocol. The RRC protocol defines various parameters and measurements used by RLM, such as the Received Signal Strength Indicator (RSSI), the Reference Signal Received Quality (RSRQ), and the Reference Signal Received Power (RSRP). These measurements are used by the RedCap UE 102a to evaluate the quality of the radio link and to determine the appropriate transmission parameters. The 3GPP TS 38.133 standard introduces RedCap UE 102a power saving by relaxing a required time for monitoring RLM reference signals of a serving cell when the RedCap UE 102a is in an RRC_CONNECTED state. This can be implemented by modifying a 1 Rx measurement THLD using the 1 Rx offset to RRM relaxation criteria for a 1 Rx RedCap UE.

In addition to relaxed measurement criteria, the RedCap UE 102a may have more conservative measurement criteria for small data transmission (SDT). In many wireless communication systems, including LTE and 5G NR cellular networks, a UE may need to transmit a small amount of data to a base station within the network. This is referred to as a small data transmission (SDT). For example, in a Cellular Internet of Things (CIoT), a sensor device equipped with a communication device such as a user equipment (UE) can take a sensor reading and then transmit the reading, or a batch of readings, to the BS. Other examples include tracking devices for Mobile Originated (MO) and Mobile Terminated (MT) use cases that report positions via the base station. The present disclosure describes, among other things, signaling mechanisms to support frequent small data transmission with and without path switching between different base stations. The 3GPP TS 38.133 Standards and/or the 3GPP TS 38.300 Standards may modify a 1 Rx measurement THLD using the 1 Rx offset to RRM conservative measurement criteria for a 1 Rx RedCap UE 102a. For instance, more conservative THLDs may be used for SDT transmissions for a 1 Rx RedCap UE 102a, such as a smaller RSRP change THLD than a standard UE, or a higher RSRP THLD than a standard UE.

FIG. 2B illustrates an operating environment 200b. The operating environment 200b depicts the RedCap UE 102a moving from point A to point B, which is in the edge area 210 between the serving cell 202 and the neighbor cell 204. At point B, the RedCap UE 102a receives signals 206 from the RAN node 106a of the serving cell 202 and signals 208 from the RAN node 106b of the neighbor cell 204.

At or around point B, the RedCap UE 102a may initiate a cell re-selection procedure that allows the RedCap UE 102a to select a more suitable cell and camp on it, such as the neighbor cell 204. When the RedCap UE 102a is in either a Camped Normally state or a Camped on Any Cell state on the serving cell 202, the RedCap UE 102a attempts to detect, synchronize, and monitor intra-frequency, inter-frequency and inter-RAT cells indicated by the serving cell 202. For intra-frequency and inter-frequency cells the serving cell 202 may not provide explicit neighbor list but carrier frequency information and bandwidth information only. The RedCap UE 102a measurement activity is also controlled by measurement rules defined in the 3GPP TS 38.133 Standards, the 3GPP TS 38.304 Standards and/or the 3GPP TS 38.331 Standards, allowing the RedCap UE 102a to limit its measurement activity in accordance with a set of relaxed measurement criteria defined by the 3GPP standards.

FIG. 2C illustrates an operating environment 200c. The operating environment 200c depicts the RedCap UE 102a moving form point B to point C, which is solely within the neighbor cell 204. At point C, the RedCap UE 102a moves from the edge area 210 to the neighbor cell 204. The RedCap UE 102a may take measurements of the signals 208 using the relaxed measurement criteria, and perform cell re-selection of the neighbor cell 204. The RedCap UE 102a camps on the RAN node 106b of the neighbor cell 204, where it receives signals 208 exclusively from the RAN node 106b. In this scenario, the neighbor cell 204 becomes a new serving cell for the RedCap UE 102a, replacing the old serving cell 202.

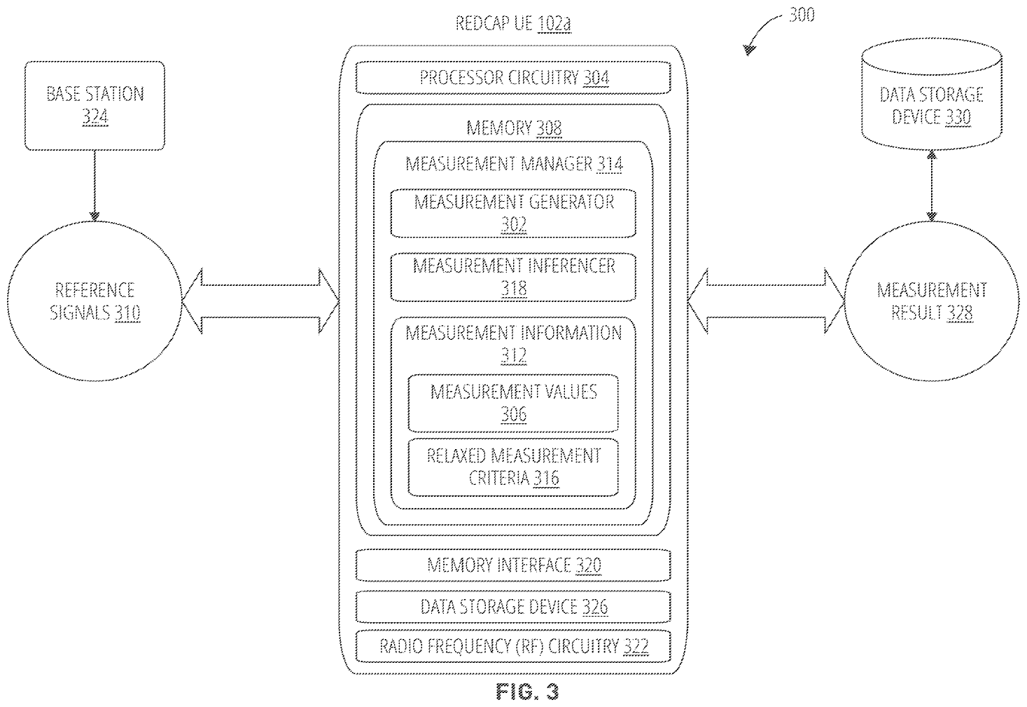

FIG. 3 illustrates an apparatus 300 suitable for implementation as a RedCap UE 102a in the wireless communications system 100. As previously discussed, the RedCap UE 102a may take measurements and actions based on one or more relaxed measurement criteria as defined by the 3GPP TS 38.133 Standards, the 3GPP TS 38.304 Standards, the 3GPP TS 38.331 Standards, or other 3GPP standards or non-3GPP standards. Embodiments are not limited in this context.

As depicted in FIG. 3, the apparatus 300 may comprise a processor circuitry 304, a memory 308 with a measurement manager 314, a memory interface 320, a data storage device 326, and radio-frequency (RF) circuitry 322. The apparatus 300 may optionally include a set of platform components (not shown) suitable for a RedCap UE 102a, such as input/output devices, memory controllers, different memory types, network interfaces, hardware ports, and so forth.

The apparatus 300 for the RedCap UE 102a may receive one or more reference signals 310 from a base station 324 via the RF circuitry 322. The base station 324 may comprise a RAN node 106a or a RAN node 106b implemented as, for example, a NodeB or an eNodeB of the wireless communications system 100. The reference signals 310 may be similar to the signals 206 and signals 208 communicated between the RedCap UE 102a and the RAN node 106a and the RAN node 106b, respectively. The reference signals 310 may comprise, for example, reference signals for SS-RSRP measurement, reference signals for SS-RSRQ measurement. BFD reference signals. RLM reference signals. SDT reference signals, or any other signals suitable for measurement or relaxed measurement in the wireless communications system 100.

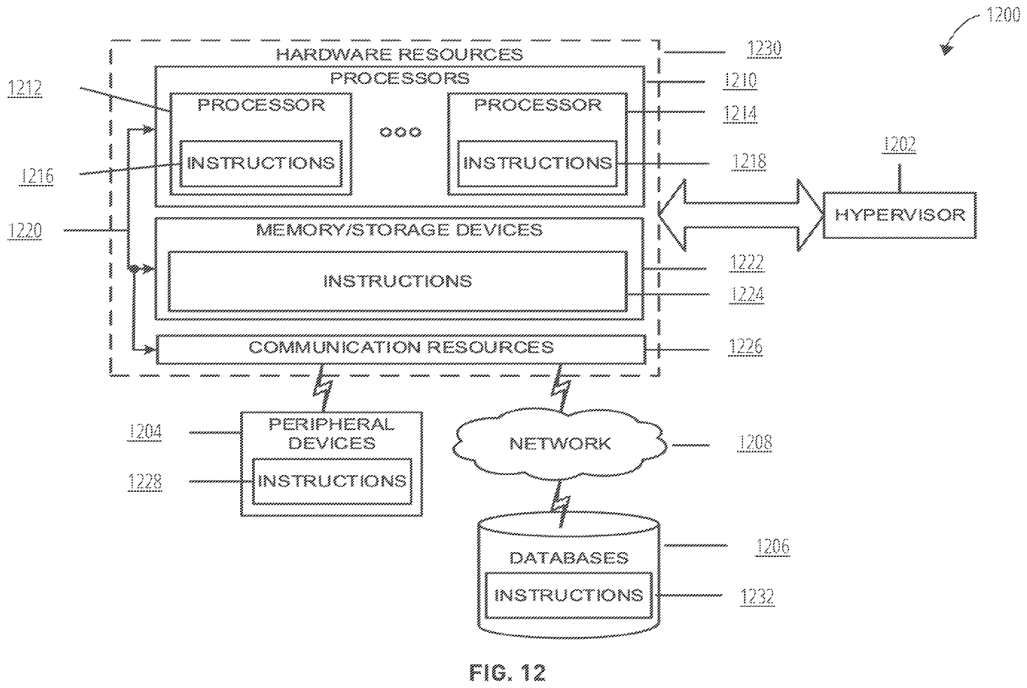

The apparatus 300 for the RedCap UE 102a may include the memory interface 320. The memory interface 320 may be arranged to send or receive, to or from a data storage device 326 or a data storage device 330, measurement information 312 for a 5G NR system. The data storage device 330 may be located external to the RedCap UE 102a (off-device) and the data storage device 326 may be located internal to the RedCap UE 102a (on-device). When the data storage device 326 is implemented on-device, the data storage device 326 may comprise volatile or non-volatile memory, as described in more detail with reference to FIG. 12.

The measurement information 312 may comprise one or more measurement values 306 as measured by the measurement generator 302 and/or relaxed measurement criteria 316 for the RedCap UE 102a. The RedCap UE 102a may be provisioned with the relaxed measurement criteria 316 by an original equipment manufacturer (OEM) or as received from the base station 324 via RRM, RRC, or other control signaling.

The apparatus 300 may include processor circuitry 304 communicatively coupled to the memory 308, the memory interface 320, the data storage device 326 and the RF circuitry 322. The memory 308 may store instructions that when executed by the processor circuitry 304 may implement or manage a measurement manager 314 for the RedCap UE 102a. The measurement manager 314 may include a measurement generator 302, a measurement inferencer 318, and measurement information 312. The measurement information 312 may include, for example, measurement values 306 and relaxed measurement criteria 316.

The measurement generator 302 may decode measurements made by instrumentation, such as instrumentation for RF circuitry, for one or more reference signals 310 received from a base station 324 of a cell, such as the serving cell 202 and/or the neighbor cell 204, to obtain one or more measurement values 306. The measurement inferencer 318 may retrieve one or more relaxed measurement criterion from a set of relaxed measurement criteria 316 associated with the RedCap UE 102a. The measurement inferencer 318 may evaluate the one or more measurement values 306 in accordance with the one or more relaxed measurement criterion of the relaxed measurement criteria 316 to obtain a measurement result 328. For instance, the measurement inferencer 318 may use a mathematical comparison operation to compare the measurement values 306 with the relaxed measurement criteria 316 to determine whether the measurement values 306 are equal to, greater than or less than the relaxed measurement criteria 316. The measurement inferencer 318 may store the measurement result 328 in the data storage device 326 and/or the data storage device 330.

The measurement inferencer 318 may take an action for the RedCap UE 102a based on the measurement result 328. For instance, the processor circuitry 304 may determine whether to select the base station 324 of the cell as a serving cell 202 for the RedCap UE 102a based on the measurement results 328. In another example, the processor circuitry 304 may determine whether to search for a base station of a neighbor cell 204 of the cell as a serving cell 202 for the RedCap UE 102a based on the measurement results 328. In yet another example, the processor circuitry 304 may determine whether to request a change in beamforming parameters based on the measurement results 328. In still another example, the processor circuitry 304 may request a change in transmission power parameters based on the measurement results 328. In still another example, the processor circuitry 304 may determine whether to initiate SDT operations based on the measurement results 328. It may be appreciated that the RedCap UE 102a may take other actions based on the measurement results 328 as defined in 3GPP or non-3GPP standards. Embodiments are not limited in this context.

In one embodiment, for example, the apparatus 300 may also include the processor circuitry 304 to perform synchronization signal based reference signal received power (SS-RSRP) measurements or synchronization signal based reference signal received quality (SS-RSRQ) measurements for a RedCap parameter of the RedCap UE 102a, such as a 1 Rx antenna, for example.

In one embodiment, for example, the apparatus 300 may also include where the cell is an intra-frequency NR cell, an inter-frequency NR cell, or an inter-radio access technology (RAT) evolved universal terrestrial radio access network (E-UTRAN) cell.

As previously discussed, the RedCap UE 102a may take measurements and actions based on one or more relaxed measurement criteria as defined by the 3GPP TS 38.133 Standards, the 3GPP TS 38.304 Standards, the 3GPP TS 38.331 Standards, or other 3GPP standards or non-3GPP standards. For instance, the 3GPP TS 38.133 Standards define at least three different types of relaxed measurement criteria 316. More particularly, the 3GPP TS 38.133 Standards define: (1) measurements of intra-frequency NR cells for the UE configured with the relaxed measurement criterion for RedCap; (2) measurements of inter-frequency NR cells for the UE configured with the relaxed measurement criterion for RedCap; and (3) measurements of inter-radio access technology (RAT) evolved universal terrestrial radio access network (E-UTRAN) cells for the UE configured with the relaxed measurement criterion for RedCap.

Excerpts from the 3GPP TS 38.133 Standards related to defining the three different types of relaxed measurement criteria 316 are presented below.

### 4.2B.2.9 Measurements of Intra-Frequency NR Cells for UE Configured With Relaxed Measurement Criterion for RedCap

### 4.2B.2.9.1 Introduction

This clause contains the requirements for measurements on intra-frequency NR cells when Srxlev≤S_{IntraSearchP} or Squal≤S_{IntraSearchQ} and when the UE is configured any of the following relaxed measurement critera:
Relaxed measurement criterion for a stationary UE defined in clause 5.2.4.9.3 in [1],
Relaxed measurement criterion for a stationary UE not at cell edge defined in clause 5.2.4.9.4 in [1],
Both low mobility criterion and stationary criterion as defined in clause 5.2.4.9.1 and 5.2.4.9.3 or 5.2.4.9.4 in [1] respectively.

The 1 Rx RedCap UE for the evaluation of one or more relaxed measurement criteria defined in clause 5.2.4.9 [1] applies:
s-SearchDeltaP-r16 as the signaled value of s-SearchDeltaP-r 16 [2]−1 decibel (dB).
s-SearchDeltaP-Stationary-r17 as the signaled value of s-SearchDeltaP-Stationary-r17 [2]−1 dB.
s-SearchThresholdP-r16 as the signaled value of s-Search ThresholdP-r16 [2]+1 dB.
s-SearchThresholdQ-r16 as the signaled value of s-SearchThresholdQ-r16 [2]+1 dB.
s-SearchThresholdP2-r17 as the signaled value of s-SearchThresholdP 2-r17 [2]+1 dB.
s-SearchThresholdQ2-r17 as the signaled value of s-Search ThresholdQ2-r17 [2]+1 dB.

### 4.2B.2.10 Measurements of Inter-Frequency NR Cells for UE Configured With Relaxed Measurement Criterion

### 4.2B.2.10.1 Introduction

This clause contains the requirements for measurements on inter-frequency NR cells when Srxlev≤S_{IntraSearchP} or Squal≤S_{IntraSearchQ} and when the UE is configured any of the following relaxed measurement critera:
Relaxed measurement criterion for a stationary UE defined in clause 5.2.4.9.3 in [1],
Relaxed measurement criterion for a stationary UE not at cell edge defined in clause 5.2.4.9.4 in [1],
Both low mobility criterion and stationary criterion as defined in clause 5.2.4.9.1 and 5.2.4.9.3 or 5.2.4.9.4 in [1] respectively.

The 1 Rx RedCap UE for the evaluation of one or more relaxed measurement criteria defined in clause 5.2.4.9 [1] applies:
s-SearchDeltaP-r16 as the signaled value of s-SearchDeltaP-r16 [2]−1 dB.
s-SearchDeltaP-Stationary-r17 as the signaled value of s-SearchDeltaP-Stationary-r 17 [2]-1 dB.
s-SearchThresholdP-r16 as the signaled value of s-Search ThresholdP-r16 [2]+1 dB.
s-Search ThresholdQ-r16 as the signaled value of s-SearchThresholdQ-r16 [2]+1 dB.
s-SearchThresholdP2-r17 as the signaled value of s-SearchThresholdP 2-r17 [2]+1 dB.
s-SearchThresholdQ2-r17 as the signaled value of s-SearchThresholdQ2-r17 [2]+1 dB.

### 4.2B.2.11 Measurements of Inter-RAT E-UTRAN Cells for UE Configured With Relaxed Measurement Criterion

### 4.2B.2.11.1 Introduction

This clause contains the requirements for measurements on inter-RAT E-UTRAN cells when Srxlev≤S_{IntraSearchP} or Squal≤S_{IntraSearchQ} and when the UE is configured any of the following relaxed measurement critera:
Relaxed measurement criterion for a stationary UE defined in clause 5.2.4.9.X in

[1],
Relaxed measurement criterion for a stationary UE not at cell edge defined in clause 5.2.4.9. Y in [1],
Both low mobility criterion and stationary criterion as defined in clause 5.2.4.9.1 and 5.2.4.9. X in [1] respectively.

The 1 Rx RedCap UE for the evaluation of one or more relaxed measurement criteria defined in clause 5.2.4.9 [1] applies:
s-SearchDeltaP-r 16 as the signaled value of s-SearchDeltaP-r 16 [2]−1 dB.
s-SearchDeltaP-Stationary-r17 as the signaled value of s-SearchDeltaP-Stationary-r17 [2]−1 dB.
s-SearchThresholdP-r16 as the signaled value of s-SearchThresholdP-r16 [2]+1 dB.
s-Search ThresholdQ-r16 as the signaled value of s-SearchThresholdQ-r16 [2]+1 dB.
s-SearchThresholdP2-r17 as the signaled value of s-SearchThresholdP 2-r17 [2]+1 dB.
s-Search ThresholdQ2-r17 as the signaled value of s-Search ThresholdQ2-r17 [2]+1 dB

The reference [2] is a reference to the 3GPP TS 38.331 Standards.

In one embodiment, for example, the apparatus 300 may also include where the measurements are measurements of intra-frequency NR cells for the UE configured with the relaxed measurement criterion for RedCap, measurements of inter-frequency NR cells for the UE configured with the relaxed measurement criterion for RedCap, or measurements of inter-RAT E-UTRAN cells for the UE configured with the relaxed measurement criterion for RedCap.

In one embodiment, for example, the apparatus 300 may also include where the relaxed measurement criterion uses s-SearchDeltaP-r16 as a signaled value of s-SearchDeltaP-r16−1 dB.

In one embodiment, for example, the apparatus 300 may also include where the relaxed measurement criterion uses s-Search DeltaP-Stationary-r17 as s signaled value of s-SearchDeltaP-Stationary-r17−1 dB.

In one embodiment, for example, the apparatus 300 may also include where the relaxed measurement criterion uses s-Search ThresholdP-r16 as the signaled value of s-SearchThresholdP-r16+1 dB.

In one embodiment, for example, the apparatus 300 may also include where the relaxed measurement criterion uses s-Search ThresholdQ-r16 as the signaled value of s-SearchThresholdQ-r16+1 dB.

In one embodiment, for example, the apparatus 300 may also include where the relaxed measurement criterion uses s-Search ThresholdP2-r17 as the signaled value of s-SearchThresholdP2-r17+1 dB.

In one embodiment, for example, the apparatus 300 may also include where the relaxed measurement criterion uses s-Search ThresholdQ2-r17 as the signaled value of s-SearchThresholdQ2-r17+1 dB.

In one embodiment, for example, the apparatus 300 may also include where the RedCap UE 102a is in an RRC idle state, an RRC inactive state, or an RRC connected state when using the relaxed measurement criteria 316 to limit measurement activity for the RedCap UE 102a for certain measurement activity in order to save power (e.g., increase battery life) for the RedCap UE 102a. For instance, the RedCap UE 102a may use the relaxed measurement criteria 316 while in the RCC_IDLE state or the RRC_INACTIVE state for certain measurement operations, such as SS-RSRP or SS-RSRQ measurement activity. In another example, the RedCap UE 102a may use the relaxed measurement criteria 316 while in the RRC_CONNECTED state for certain measurement operations, such as RLM and BFD measurement activity.

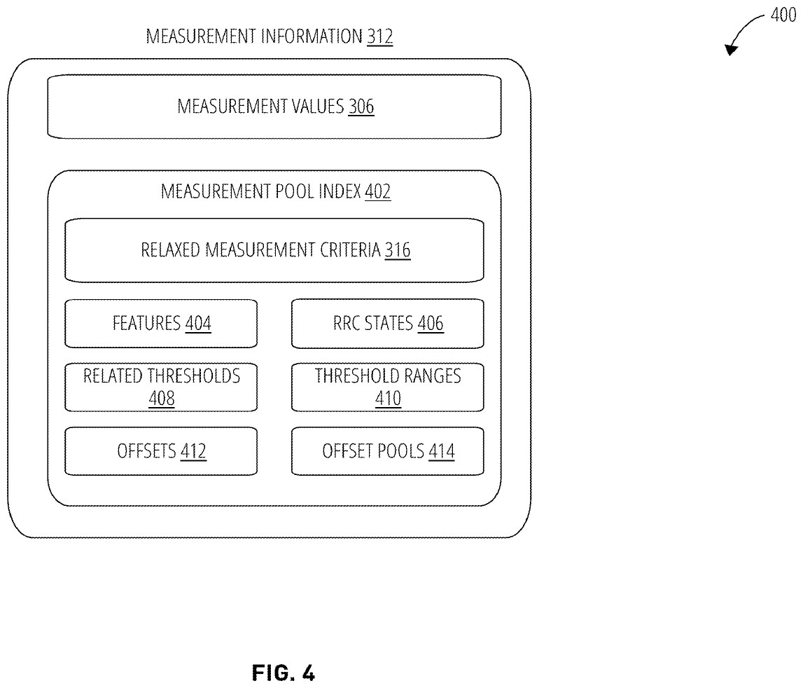

FIG. 4 illustrates a more detailed view of a data schema 400 for the measurement information 312. As depicted in FIG. 4, the RedCap UE 102a may store the relaxed measurement criteria 316 in a measurement pool index 402.

The measurement pool index 402 may store the relaxed measurement criteria 316 in a data structure using a data schema 400 that allows the processor circuitry 304 of the apparatus 300 implementing the RedCap UE 102a to rapidly retrieve a given relaxed measurement criterion of the relaxed measurement criteria 316. For example, the processor circuitry 304 may retrieve the relaxed measurement criterion from a measurement pool index 402. The measurement pool index 402 may store relaxed measurement criteria 316 indexed by one or more of a set of features 404, RRC states 406, related thresholds 408, threshold ranges 410, offsets 412 associated with a signal-to-noise (SNR) scheme, or offset pools 414. In one embodiment, for example, the processor circuitry 304 may quickly retrieve the relaxed measurement criteria 316 from the measurement pool index 402 based on a given set of candidate features and/or a given SNR scheme.

An example of a measurement pool index 402 may be provided in Table 1.

TABLE 1

| | | THLD | | |
|---|---|---|---|---|
| Features | Related THLD | RANGE | 1 Rx. Offset | Offset Pool |
| Rel-15 | rsrp- | RSRP-Range | RSRP Offset: | offset_{RSRP} |
| RA-related | ThresholdSSB, | (L1-RSRP) | low SNR | offset_{cg-SDT-RSRP-Change} |
| procedure | rsrp- | | regime | offset_{RSRQ} |
| | ThresholdCSI- | | | offset_{SINR} |
| | RS, | | | offset_{RSRP Change} |
| | msgA-RSRP- | | | |
| | ThresholdSSB, | | | |
| | msgA-RSRP- | | | |
| | Threshold, | | | |
| | rsrp- | | | |
| | ThresholdBFR. | | | |
| Rel-17 | sdt-RSRP- | RSRP-Range | RSRP Offset | offset_{ReselectionThreshold}* |
| SDT | Threshold | RSRP-Range | RSRP Offset | offset_{ReselectionThresholdQ}* |
| procedure | cg-SDT-RSRP- | ENUM {dB2, | cg-SDT-RSRP- | offset_{L3-RSRPchange} |
| (INACTIVE) | ThresholdSSB | dB4, dB6, dB8, | Change Offset: | offset_{L3-Quality} |
| | cg-SDT-RSRP- | dB10, dB14, | gNB | |
| | ChangeThreshold | dB18, | configurable | |
| | | dB22, dB26, | SNR regime | |
| | | dB30, dB34, | | |
| | | spare5, spare4, | | |
| | | spare3, | | |
| | | spare2, spare1} | | |
| Rel-15 | absThreshSS- | ThresholdNR: | RSRP Offset | |
| Cell (re) | BlocksConsolidation | RSRP/Q/SINR- | RSRQ Offset | |
| selection | Q-RxLevMin/ | Range | SINR Offset: | |
| (IDLE) | Q-QualMin | (L1 | low SNR regime | |
| (INACTIVE) | | RSRP/RSRQ/SINR) | RSRP Offset/ | |
| | | Min. | RSRQ Offset: | |
| | | RSRP/RSRQ | low SNR regime | |
| | | level | | |
| Rel-16/17 | s- | ENUM {dB3, | RSRP Change | |
| RRM | SearchDeltaP- | dB6, dB9, | Offset: | |
| relaxation | r16, | dB12, dB15, | high SNR | |
| (IDLE) | s- | spare3, spare2, | regime | |
| (INACTIVE) | SearchDeltaP- | spare1} | ReselectionThreshold | |
| | Stationary-r17 | ReselectionThreshold | Offset | |
| | s- | Reselection | ReselectionThresholdQ | |
| | SearchThresholdP/ | ThresholdQ | Offset: | |
| | Q-r16, | | high SNR | |
| | s- | | regime | |
| | SearchThresholdP2/ | | | |
| | Q2-r17 | | | |
| Rel-17 | s- | ENUM {FFS} - | L3-RSRP | |
| RLM/BFD | SearchDeltaP- | L3 filtered | change offset | |
| relaxation | Connected-r17 | metric | L3-Quality | |
| (CONNECTED) | Qin, BFD/RLM + | X in ENUM | offset: | |
| | Offset X | {db2, db4, db6, | higher layer | |
| | | db8} - filtered | filtered metric | |
| | | metric | | |

It is worth to note that the RSRP/RSRQ Offset is for low SNR regime while the s-SearchThresholdP/Q is for RRM relaxation for higher SNR regimes. Thus, the offset can be optimized depending on a given SNR regime.

In one embodiment, for example, the RedCap UE 102a may be configured with a 1 Rx antenna when using the relaxed measurement criteria 316 to limit measurement activity of the RedCap UE 102a, which is a reduced capability relative to the standard UE 102b configured with a 2 Rx antenna. The processor circuitry 304 of the apparatus 300 implemented by the RedCap UE 102a with the 1 Rx antenna may retrieve the relaxed measurement criteria 316 from the measurement pool index 402 in a number of different ways.

In one embodiment, for example, the processor circuitry 304 may use a SNR regime to identify a separately configurable offset for 1 Rx, where UE behavior is compared with legacy 2 Rx UEs. The SNR regime is categorized by the nature of the feature, such as a lower SNR, higher SNR and gNB configurable.

In one embodiment, for example, the processor circuitry 304 may use higher layer filtering applicability to identify a separately configurable offset for 1 Rx, where UE behavior is compared with legacy 2 Rx UEs.

In one embodiment, for example, the processor circuitry 304 may use a metric quantity to identify the separately configurable offset for 1 Rx, where the UE behavior is compared with legacy 2 Rx UEs. The metric may be categorized by RSRP, RSRQ, SINR, and so forth. When using an RSRP metric, further categorization may be made for an absolute RSRP threshold and a RSRP change threshold.

In one embodiment, for RRM relaxation in IDLE or INACTIVE states as defined in 3GPP Release 16 and Release 17, a separately configurable offset may be introduced that is optimized for a higher SNR regime. In this case, for example, the offsets 412 may represent offset_{RSRP Change}, offset_{ReselectionThreshold} and offset_{Reselection ThresholdQ}.

In one embodiment, for RRM relaxation in CONNECTED state for RLM or BFD relaxation as defined 3GPP Release 17, a separately configurable offset may be introduced that considers the effects of higher-layer filtering. In this case, for example, the offsets may represent offset_{L3 RSRP Change} and offset_{RL3 Quality}.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

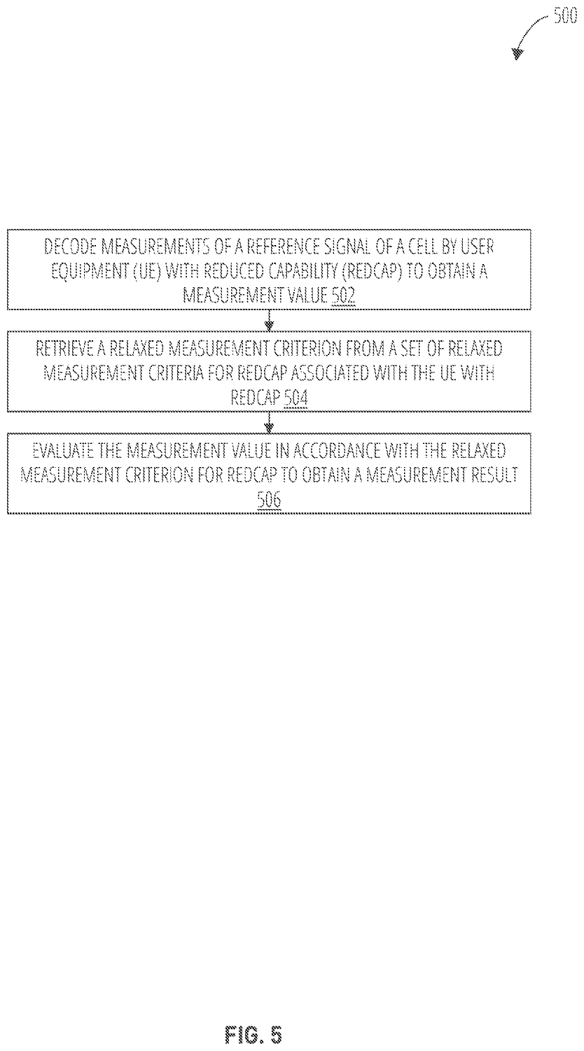

FIG. 5 illustrates an embodiment of a logic flow 500. The logic flow 500 may be representative of some or all of the operations executed by one or more embodiments described herein. For example, the logic flow 500 may include some or all of the operations performed by devices or entities within the wireless communications system 100, such as the RedCap UE 102a. More particularly, the logic flow 500 illustrates a use case where the RedCap UE 102a may use the relaxed measurement criteria 316 stored in the measurement pool index 402. Embodiments are not limited in this context.

In block 502, logic flow 500 decodes or performs measurements of a reference signal from a base station of a cell by user equipment (UE) with reduced capability (RedCap) to obtain a measurement value. In block 504, logic flow 500 retrieves a relaxed measurement criterion from a set of relaxed measurement criteria for RedCap associated with the UE with RedCap. In block 506, logic flow 500 evaluates the measurement value in accordance with the relaxed measurement criterion for RedCap to obtain a measurement result.

The logic flow 500 may be implemented by the RedCap UE 102a. By way of example, the RedCap UE 102a may decode or perform measurements of reference signals 310 from a base station 324 of a cell of the wireless communications system 100 to obtain one or more measurement values 306. The RedCap UE 102a may perform synchronization signal based reference signal received power (SS-RSRP) measurements or synchronization signal based reference signal received quality (SS-RSRQ) measurements for the reference signals 310. The cell may comprise the serving cell 202 or the neighbor cell 204 implemented as different types of cells, such as an intra-frequency NR cell, an inter-frequency NR cell, or an inter-RAT E-UTRAN cell, among others. The RedCap UE 102a may take measurements for each type of cell.

The RedCap UE 102a may retrieve one or more relaxed measurement criterion from a set of relaxed measurement criteria 316 for RedCap associated with the RedCap UE 102a. The RedCap UE 102a may evaluate the measurement values 306 in accordance with the relaxed measurement criterion for RedCap to obtain a measurement result 328.

The relaxed measurement criteria 316 may include or use a s-SearchDeltaP-r16 as a signaled value of s-Search DeltaP-r16−1 dB, a s-SearchDeltaP-Stationary-r17 as s signaled value of s-SearchDeltaP-Stationary-r17−1 dB, a s-SearchThresholdP-r16 as the signaled value of s-SearchThresholdP-r16+1 dB, a s-SearchThresholdQ-r16 as the signaled value of s-SearchThresholdQ-r16+1 dB, a s-SearchThresholdP2-r17 as the signaled value of s-SearchThresholdP2-r17+1 dB, or a s-SearchThresholdQ2-r17 as the signaled value of s-SearchThresholdQ2-r17+1 dB.

The RedCap UE 102a may retrieve the relaxed measurement criterion from a measurement pool index 402, the measurement pool index 402 to store relaxed measurement criteria 316 indexed by features 404, RRC states 406, related thresholds 408, threshold ranges 410, offsets 412 associated with a signal-to-noise (SNR) scheme, and/or offset pools 414.

The RedCap UE 102a may receive RF signals representing the reference signals 310 from the base station 324 via RF circuitry 322.

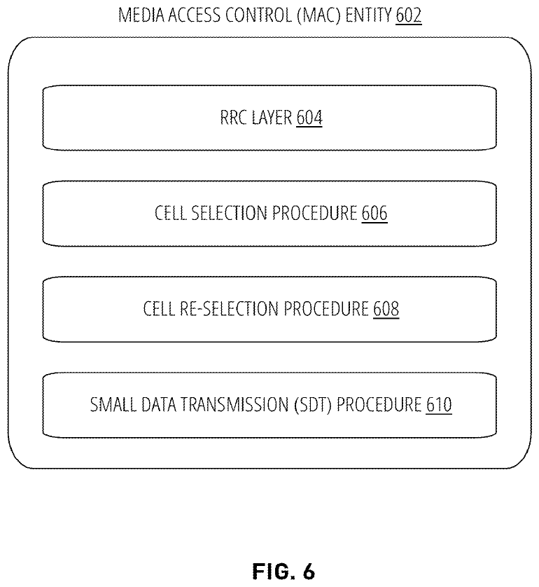

FIG. 6 illustrates a medium access control (MAC) entity 602 suitable for implementation as part of the apparatus 300 and the RedCap UE 102a. The MAC entity 602 is part of the MAC layer that is responsible for managing access to the shared radio resource, controlling the transmission and reception of data on the wireless channel, and ensuring the quality of service (QoS) requirements of different services are met. The MAC layer sits above the physical layer and below the radio link control (RLC) layer in the protocol stack. In 3GPP, the MAC layer defines several protocols and functions such as MAC protocol data units (PDUs), MAC multiplexing and demultiplexing, power control, scheduling, and priority handling. These functions are essential for efficient and reliable communication in wireless networks.

As previously described, the RedCap UE 102a may use the relaxed measurement criteria 316 stored in the measurement pool index 402 as a trigger for a particular 3GPP operation or procedure for the RedCap UE 102a. A media access control (MAC) entity 602 may be configured by an RRC layer 604 with various 3GPP procedures. In various embodiments, the RRC layer 604 may configure the MAC entity 602 with a cell selection procedure 606, a cell re-selection procedure 608, and a small data transmission (SDT) procedure 610. It may be appreciated that other 3GPP procedures may be implemented as well. Embodiments are not limited in this context.

In one embodiment, for example, the RRC layer 604 may configure the MAC entity 602 with a cell selection procedure 606, such as defined in 3GPP TS 38.133 Standards in Section 4 titled “SA: RRC_IDLE state mobility.” As stated in section 4.1, after a UE has switched on and a PLMN has been selected, a cell selection process takes place, as described in 3GPP TS 38.304 Standards. This process allows the UE to select a suitable cell where to camp on in order to access available services. In this process, the UE can use stored information (Stored information cell selection) or not (Initial cell selection)

In one embodiment, for example, the RRC layer 604 may configure the MAC entity 602 with a cell re-selection procedure 608, such as defined in 3GPP TS 38.133 Standards in Section 4 titled “SA: RRC_IDLE state mobility.” As stated in section 4.2, the cell re-selection procedure allows the UE to select a more suitable cell and camp on it. When the UE is in either Camped Normally state or Camped on Any Cell state on a cell, the UE shall attempt to detect, synchronize, and monitor intra-frequency, inter-frequency and inter-RAT cells indicated by the serving cell. For intra-frequency and inter-frequency cells the serving cell may not provide explicit neighbor list but carrier frequency information and bandwidth information only. UE measurement activity is also controlled by measurement rules defined in the 3GPP TS 38.304 Standards, allowing the UE to limit its measurement activity.

In one embodiment, for example, the RRC layer 604 may configure the MAC entity 602 with a SDT procedure 610, such as defined in 3GPP TS 38.300 standards. The RedCap UE 102a may need to transmit a small amount of data to a base station 324 within the wireless communications system 100. This is referred to as a small data transmission (SDT). For example, in a Cellular Internet of Things (CIoT), a sensor device equipped with a communication device such as a user equipment (UE) can take a sensor reading and then transmit the reading, or a batch of readings, to the base station 324. Other examples include tracking devices for Mobile Originated (MO) and Mobile Terminated (MT) use cases that report positions via a base station 324. The SDT procedure 610 implements signaling mechanisms to support frequent small data transmission with and without path switching between different base stations.

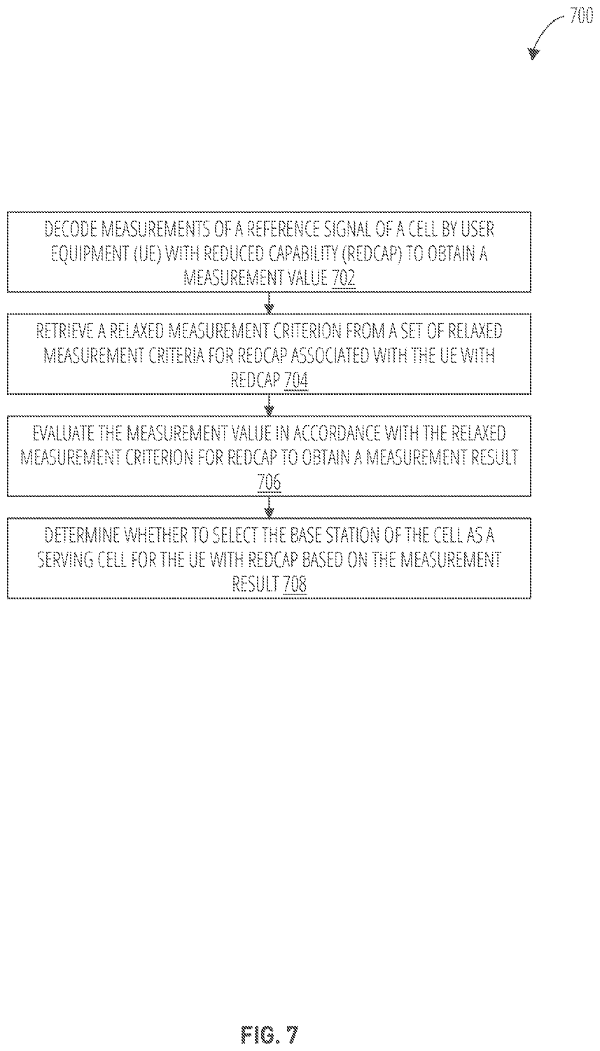

FIG. 7 illustrates an embodiment of a logic flow 700. The logic flow 700 may be representative of some or all of the operations executed by one or more embodiments described herein. For example, the logic flow 700 may include some or all of the operations performed by devices or entities within the wireless communications system 100, such as the RedCap UE 102a. More particularly, the logic flow 700 illustrates a use case where the RedCap UE 102a may use the relaxed measurement criteria 316 stored in the measurement pool index 402 as a trigger for a particular operation or procedure for the RedCap UE 102a, such as a cell selection procedure 606, for example. Embodiments are not limited in this context.

In block 702, logic flow 700 decodes or performs measurements of a reference signal from a base station of a cell by user equipment (UE) with reduced capability (RedCap) to obtain a measurement value. In block 704, logic flow 700 retrieves a relaxed measurement criterion from a set of relaxed measurement criteria for RedCap associated with the UE with RedCap. In block 706, logic flow 700 evaluates the measurement value in accordance with the relaxed measurement criterion for RedCap to obtain a measurement result. In block 708, logic flow 700 determines whether to select the base station of the cell as a serving cell for the UE with RedCap based on the measurement result.

By way of example, the RedCap UE 102a may decode or perform measurements of one or more reference signals 310 from a base station 324 of a cell to obtain one or more measurement values 306. The RedCap UE 102a may retrieve one or more relaxed measurement criterion from a set of relaxed measurement criteria 316 for RedCap associated with the RedCap UE 102a. The RedCap UE 102a may evaluate the one or more measurement values 306 in accordance with the one or more relaxed measurement criterion for RedCap to obtain one or more measurement results 328. The RedCap UE 102a may determine whether to select the base station 324 of the cell as a serving cell 202 for the RedCap UE 102a based on the measurement results 328.

Other examples for use cases where the RedCap UE 102a may use the relaxed measurement criteria 316 stored in the measurement pool index 402 as a trigger for a particular operation or procedure for the RedCap UE 102a are as follows.

Example 1 may include the use of SNR regime to identify the separately configurable offset for 1 Rx. UE behavior comparing with legacy 2 Rx. UEs.

Example 2 may include the features of Example 1 and further include the SNR regime is categorized by the nature of the feature—low SNR, high SNR and gNB configurable.

Example 3 may include the use of higher layer filtering applicability to identify the separately configurable offset for 1 Rx. UE behavior comparing with legacy 2 Rx. UEs.

Example 4 may include the use of metric quantity to identify the separately configurable offset for 1 Rx. UE behavior comparing with legacy 2 Rx. UEs.

Example 5 may include the features of Example 4 and further include the metric is categorized by RSRP, RSRQ and SINR

Example 6 may include the features of Example 41 and further include when using RSRP metric, further categorization by absolute RSRP threshold and RSRP change threshold

Example 7 may include for RRM relaxation in IDLE/INACTIVE in Rel-16/17, introduce separately configurable offset optimized for high SNR regime.

Example 8 may include the features of Example 7 and further include the offsets are representing offset_{RSRP Change}, offset_{ReselectionThreshold} and offset_{ReselectionThresholdQ}

Example 9 may include for RLM/BFD relaxation in CONNECTED in Rel-17, introduce separately configurable offset considering the effects of higher-layer filtering.

Example 10 may include the features of Example 9 and further include the offsets are representing offsetL_{3 RSRP Change} and offset_{RL3 Quality}

Example 11 is a method of configuring user equipment (UE) by a new radio (NR) network, comprising: collecting candidate features relating to evaluation thresholds for operations of the UE; identifying a pool of separately configurable offset based on the candidate features and depending on signal to noise ratio (SNR) regimes and an applicability of higher-layer filtering; selecting a configurable offset from the pool of configurable offsets of separately configurable offsets based on a selected SNR regime and the applicability of higher-layer filtering.

Example 12 may include the method of example 11, wherein the SNR regimes include a low SNR regime, a high SNR regime or a base station configurable regime.

Example 13 is a method of operating user equipment (UE) in a new radio (NR) network, comprising: receiving data identifying a configurable offset from the pool of configurable offsets of separately configurable offsets based on a selected signal to noise ratio (SNR) regime and an applicability of higher-layer filtering; configuring the configurable offset in accordance with the received data.

Example 14 may include the method of example 13, wherein the SNR regimes include a low SNR regime, a high SNR regime or a base station configurable regime.

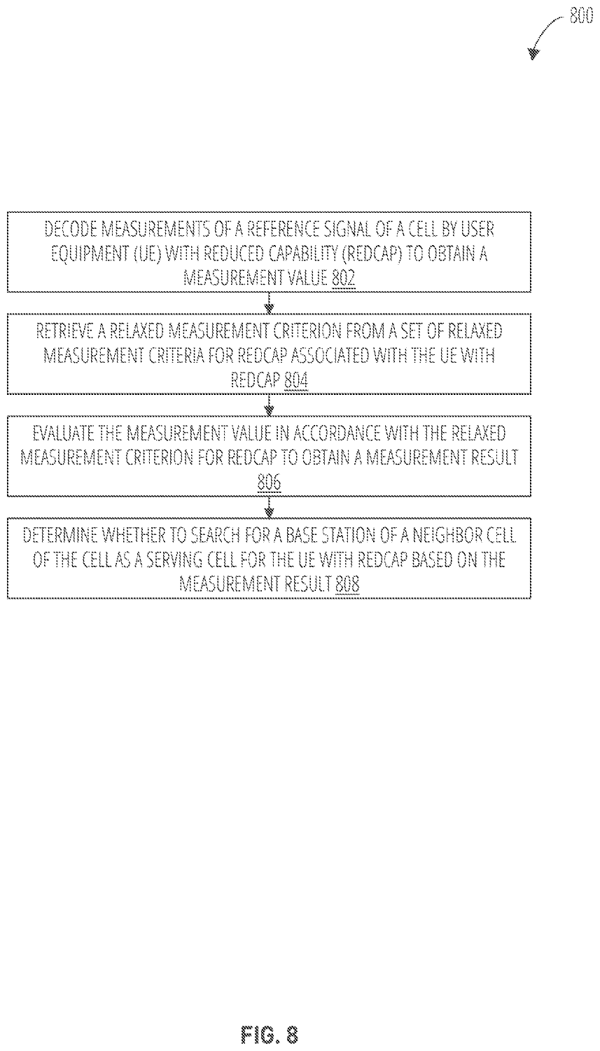

FIG. 8 illustrates an embodiment of a logic flow 800. The logic flow 800 may be representative of some or all of the operations executed by one or more embodiments described herein. For example; the logic flow 800 may include some or all of the operations performed by devices or entities within the wireless communications system 100, such as the RedCap UE 102a. More particularly, the logic flow 800 illustrates a use case where the RedCap UE 102a may use the relaxed measurement criteria 316 stored in the measurement pool index 402 as a trigger for a particular operation or procedure for the RedCap UE 102a, such as a cell re-selection procedure 608, for example. Embodiments are not limited in this context.

In block 802, logic flow 800 performs measurements of a reference signal from a base station of a cell by user equipment (UE) with reduced capability (RedCap) to obtain a measurement value. In block 804, logic flow 800 retrieves a relaxed measurement criterion from a set of relaxed measurement criteria for RedCap associated with the UE with RedCap. In block 806, logic flow 800 evaluates the measurement value in accordance with the relaxed measurement criterion for RedCap to obtain a measurement result. In block 808, logic flow 800 determines whether to search for a base station of a neighbor cell of the cell as a serving cell for the UE with RedCap based on the measurement result.

By way of example, the RedCap UE 102a may perform measurements of one or more reference signals 310 from a base station 324 of a cell to obtain one or more measurement values 306. The RedCap UE 102a may retrieve one or more relaxed measurement criterion from a set of relaxed measurement criteria 316 for RedCap associated with the RedCap UE 102a. The RedCap UE 102a may evaluate the one or more measurement values 306 in accordance with the one or more relaxed measurement criterion for RedCap to obtain one or more measurement results 328. The RedCap UE 102a may determine whether to search for a base station of a neighbor cell 204 to become a new serving cell 202 for the RedCap UE 102a based on the measurement results 328.

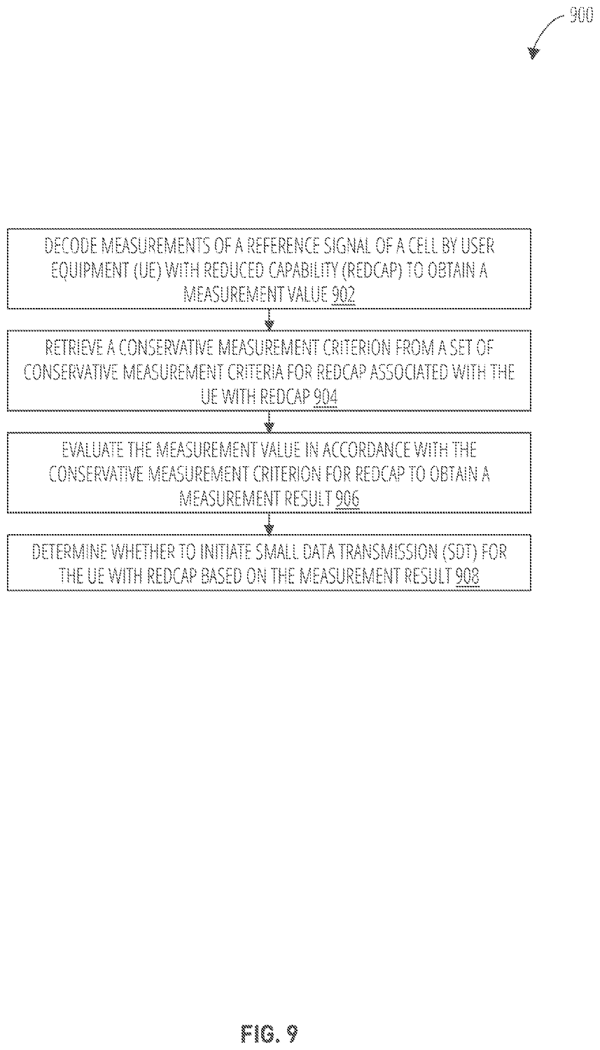

FIG. 9 illustrates an embodiment of a logic flow 900. The logic flow 900 may be representative of some or all of the operations executed by one or more embodiments described herein. For example; the logic flow 900 may include some or all of the operations performed by devices or entities within the wireless communications system 100, such as the RedCap UE 102a. More particularly, the logic flow 900 illustrates a use case where the RedCap UE 102a may use the relaxed measurement criteria 316 stored in the measurement pool index 402 as a trigger for a particular operation or procedure for the RedCap UE 102a, such as an SDT procedure 610, for example. Embodiments are not limited in this context.

In block 902, logic flow 900 decodes or performs measurements of a reference signal from a base station of a cell by user equipment (UE) with reduced capability (RedCap) to obtain a measurement value. In block 904, logic flow 900 retrieves a conservative measurement criterion from a set of conservative measurement criteria for RedCap associated with the UE with RedCap. In block 906, logic flow 900 evaluates the measurement value in accordance with the conservative measurement criterion for RedCap to obtain a measurement result. In block 908, logic flow 900 determines whether to initiate small data transmission (SDT) for the UE with RedCap based on the measurement result.

By way of example, the RedCap UE 102a may decode or perform measurements of one or more reference signals 310 from a base station 324 of a cell to obtain one or more measurement values 306. The RedCap UE 102a may retrieve one or more conservative measurement criterion from a set of conservative measurement criteria for RedCap associated with the RedCap UE 102a. The RedCap UE 102a may evaluate the one or more measurement values 306 in accordance with the one or more conservative measurement criterion for RedCap to obtain one or more measurement results 328. The RedCap UE 102a may determine whether to initiate a small data transmission (SDT) for the RedCap UE 102a based on the measurement results 328. For instance, more conservative THLDs may be used for SDT transmissions, such as a smaller RSRP change THLD than a standard UE. The RedCap UE 102a may implement a smaller RSRP change THLD by subtracting a 1.0 dB offset in a low mobility decision for “RRM relaxation” or “SDT transmission.” In another example, the RedCap UE 102a may use a higher RSRP THLD than a standard UE. A higher RSRP THLD may be implemented by adding 1.0 dB offset for a no-cell edge decision for “RRM relaxation” or “SDT transmission.”

The feature of small data transmission (SDT) enables the RedCap UE 102a to transmit small size packets while in an RRC_INACTIVE state in 5G NR. This avoids overhead of RRC state transition as well as radio link monitoring and measurement procedures normally performed when in an RRC_CONNECTED state, which would be inefficient for small data transmission. The SDT procedure 610 can be performed either by a Random Access (RA) procedure with a 2-step RA type or a 4-step RA type (i.e., RA-SDT) or by configured grant Type 1 (i.e., CG-SDT) For reliable SDT transmission, the base station 324 configures a set of parameters for the RedCap UE 102a to decide whether conditions for initiating SDT procedure are fulfilled or not. For example, one is data volume threshold (sdt-DataVolumeThreshold). Another example is for RSRP threshold, i.e., sdt-RSRP-Threshold for RA-SDT and eg-SDT-RSRP-ThresholdSSB for CG-SDT. For CG-SDT, additional eg-SDT-RSRP-ChangeThreshold which is a RSRP change threshold for the increase/decrease of RSRP can be configured for time alignment (TA) validation purpose. For the RedCap UE 102a with a 1 Rx antenna, it is important to define a proper SDT transmission method since the RSRP measurement accuracy is worse relative to a legacy non-RedCap UE with a 2 Rx antenna, such as the standard UE 102b, for example.

The RSRP related thresholds for SDT procedure may be defined as follows. Once an SDT-related absolute RSRP threshold H_{2Rx, RSRP absolute} and RSRP change threshold H2_{Rx, RSRP change} based on legacy signaling and RSRP range is defined for the standard UE 102b, the SDT-related absolute RSRP threshold may be defined as H_{1Rx, RSRP absolute}=H_{2Rx, RSRPabsolute}+offsetR_{SRP, absolute} and H_{1Rx, RSRP change}=H_{2Rx, RSRP change}+offset_{RSRP change}, respectively, for the RedCap UE 102a using the 1 Rx antenna. For the SDT procedure 610, the absolute RSRP threshold includes sdt-RSRP-Threshold and eg-SDT-RSRP-ThresholdSSB while RSRP change threshold includes cg-SDT-RSRP-ChangeThreshold. To achieve a similar level of reliability between the RedCap UE 102a using 1 Rx and the standard UE 102b using 2 Rx, under the worse measurement accuracy of the RedCap UE 102a, the offset_{RSRP, absolute} would be set to no less than 0 dB while the offset_{RSRP, change} would be set no higher than 0 dB.

This technique effectively solves the problem SDT transmission validation method for a RedCap UE 102a using a 1 Rx. The separate offset_{RSRP, absolute} and offset_{RSRP change} can define reliable conditions for SDT transmission by capturing the RSRP measurement accuracy degradation compared with the standard UE 102b with the 2 Rx antenna.

A general procedure for small data transmission (SDT) can summarized as below based on the 3GPP MAC specification. The MAC entity 602 may be configured by RRC with SDT. The RRC layer 604 may initiate the SDT procedure 610. The SDT procedure 610 can be performed either by a Random Access (RA) procedure with a 2-step RA type or a 4-step RA type (i.e., RA-SDT) or by configured grant Type 1 (i.e., CG-SDT).

The RRC layer 604 configures the following parameters for the SDT procedure 610:
sdt-DataVolumeThreshold: data volume threshold for the UE to determine whether to perform SDT procedure;
sdt-RSRP-Threshold: RSRP threshold for UE to determine whether to perform SDT procedure;
cg-SDT-RSRP-ThresholdSSB: an RSRP threshold configured for SSB selection for CG-SDT.

The MAC entity 602 shall, if initiated by the upper layers for the SDT procedure 610:
1> if the data volume of the pending UL data across all RBs configured for SDT is less than or equal to sdt-Data VolumeThreshold.

It is worthy to note that for the SDT procedure 610, the MAC entity 602 also considers the suspended resource blocks (RBs) configured with SDT for data volume calculation. The RedCap UE 102a may calculate the data volume for the suspended RBs differently based on a given implementation. A size of the common control channel (CCCH) message is not considered for data volume calculation.
1> if the RSRP of the downlink pathloss reference is higher than sdt-RSRP-Threshold:
2> if the Serving Cell for SDT is configured with supplementary uplink as specified in TS 38.331 RRC specification; and
2> if the RSRP of the downlink pathloss reference is less than rsrp-ThresholdSSB-SUL:
3> select the SUL (Supplementary Uplink) carrier.
2> else:
3> select the NUL (Normal Uplink) carrier.
2> if CG-SDT is configured on the selected UL carrier, and TA of the configured grant Type 1 resource is valid according to clause for timing alignment validation condition; and
2> if at least one SSB configured for CG-SDT with SS-RSRP above cg-SDT-RSRP-ThresholdSSB is available:
3> indicate to the upper layers that the conditions for initiating SDT procedure are fulfilled;
3> perform CG-SDT procedure on the selected UL carrier
2> else if a set of Random Access resources to indicate RA-SDT are available on the selected UL carrier:
3> consider cg-SDT-TimeAlignmentTimer as expired and perform the corresponding actions.
3> indicate to the upper layers that the conditions for initiating SDT procedure are fulfilled.
2> else:
3> indicate to the upper layers that the conditions for initiating SDT procedure are not fulfilled.
1> else:
2> indicate to the upper layers that the conditions for initiate SDT procedure are not fulfilled.

If the RA-SDT is selected from above and after the Random Access (RA) procedure is successfully completed, the RedCap UE 102a monitors PDCCH addressed to C-RNTI until the RA-SDT procedure is terminated. If the CG-SDT is selected from above and after the initial transmission for CG-SDT is performed, the RedCap UE 102a monitors PDCCH addressed to C-RNTI and CS-RNTI until the CG-SDT procedure is terminated.

The timing alignment (TA) validation for CG-SDT is defined as below. The RRC layer 604 configures the following parameters for validation for CG-SDT:
cg-SDT-RSRP-ChangeThreshold: RSRP threshold for the increase/decrease of RSRP for time alignment validation.

The MAC entity 602 shall:
1> if the UE is configured with measObject for the serving cell where the UE receives configuration for CG-SDT:
2> store the RSRP of the downlink pathloss reference derived based on the measObject configured for the serving cell as in the 3GPP TS 38.331 Standards defining RRC operations.

The MAC entity 602 shall consider the TA of the initial CG-SDT transmission with CCCH message to be valid when the following condition is fulfilled:
1> compared to the stored downlink pathloss reference RSRP value, the current RSRP value of the downlink pathloss reference calculated as specified in TS 38.133 RRM specification has not increased/decreased by more than cg-SDT-RSRP-ChangeThreshold, if configured;
1> cg-SDT-TimeAlignmentTimer is running

A detailed RSRP measurement framework is defined in the 3GPP TS 38.133 Standards for RRM operations, as follows:
5.x.3 TA validation requirements

When cg-SDT-RSRP-Change Threshold is configured for TA validation based on the RSRP change criterion, the UE is allowed to transmit using CG-SDT using the timing derived using the latest available N_{TA} value as specified in subclause 7.1 provided that
the first RSRP (RSRP₁) measurement and the second RSRP (RSRP₂) measurements used in the TA validation are valid measurements and,
timing alignment validation for transmission using CG-SDT is valid according to the validation criteria

RSRP₁ and RSRP2 are considered valid provided that the conditions in Table 2 and Table 3 are met for FR1 and FR2-1.

TABLE 2

| Measurement | FR1 |
|---|---|
| RSRP₁ | (T1 − min(640 ms, M1*T_{DRX})) ≤ T1′ ≤ (T1 + |
| | min(640 ms, M1*T_{DRX})) |
| RSRP₂ | (T2 − min(640 ms, M1*T_{DRX})) ≤ T2′ ≤ T2 |

Table 2 illustrates a set of valid measurements for FR1.

TABLE 3

| Measurement | FR2-1 |
|---|---|
| RSRP₁ | (T1 − [X1]) ≤ T1′ ≤ (T1 + [X1]) |
| RSRP₂ | (T2 − [X1]) ≤ T2′ ≤ T2 |

Table 3 illustrates a set of valide measurements for FR2-1

If at least one of RSRP₁ and RSRP₂ is considered to be invalid based on the above conditions, then the RedCap UE 102a shall not validate the CG-SDT using RSRP₁ and RSRP₂ and shall not transmit using CG-SDT. Additionally, the RedCap UE 102a shall not transmit in an CG-SDT occasion that occurs more than [Z ms] after T2.

Where:
T1 is the time when the latest was obtained by the UE via Timing Advance Command MAC control element.
T1′ is the time when the UE has completed RSRP₁.
T2 is the time when the UE performs TA validation for transmission using CG-SDT.
T2′ is the time when the UE has completed RSRP₂.
TORX is the DRX cycle length in ms.
M1 the scaling factor for measurement period

Generally, embodiments herein may provide techniques suitable for the SDT procedure 610 when implemented for the RedCap UE 102a. Towards this end, the following changes may be enacted while keeping the legacy SDT procedure framework. In the described technique, the RSRP related thresholds for SDT procedure 610 may be defined as follows.

Once SDT-related absolute RSRP threshold H_{2Rx, RSRP absolute} and RSRP change threshold H_{2Rx, RSRP change} based on legacy signaling and RSRP range defined for UE with 2 Rx. antenna, define:

H_{1Rx, RSRP absolute}=H_{2Rx, RSRP absolute}+offset_{RSRP, absolute}

H_{1Rx, RSRP change}=H_{2Rx, RSRP change}+offset_{RSRP, change}

respectively for the RedCap UE 102a using 1 Rx antenna.

For SDT transmission, absolute RSRP threshold includes sdt-RSRP-Threshold and cg-SDT-RSRP-ThresholdSSB while RSRP change threshold includes cg-SDT-RSRP-ChangeThreshold. To achieve a similar level of reliability between a 1 Rx UE and a 2 Rx UE, offset_{RSRP, absolute} would be set to no less than 0 dB while offset_{RSRP, change} would be set to no higher than 0 dB. This form of offset signaling provides an advantage from a signaling overhead perspective especially for an absolute RSRP threshold. For an RSRP change threshold, signaling of H_{1Rx, RSRP change} itself rather than offset_{RSRP change} could be a viable solution. Examples are provided as follows.

Example 1 may use two RSRP offsets offset_{RSRP absolute} and offset_{RSRP change} for the RSRP decision threshold of 1 Rx. UE behavior comparing with legacy 2 Rx. UEs.

Example 1-1 may Alternately, directly define and inform UE of H_{1Rx, RSRP change}itself rather than offset_{RSRP change} for 1 Rx. UE.

Example 2 may include the RSRP decision thresholds for UE behavior includes:
Opt. 1 Threshold for UE to perform neighbor cell search and/or synchronization source search
Opt.2 Threshold for UE to perform uplink data transmission
Opt.3 Threshold for UE to perform resource selection in the predefined resource pool
Opt.4 Threshold for UE to perform measurement for radio link monitoring and or status decision

Example 3 may include particularly for Opt. 2 in example 2, UE perform timing alignment validation for configured-grant small data transmission either by adding offset_{RSRP change} into H_{2Rx, RSRP change} Or H_{1Rx, RSRP change} itself while offset_{RSRP absolute} is used for the initiation of CG-SDT procedure.

Example 4 may include a method to be performed by a reduced capacity (RedCap) user equipment (UE), one or more elements of a RedCap UE, and/or an electronic device that includes a RedCap UE, wherein the method comprises: identifying two reference signal received power (RSRP) offset-related parameters; and performing a RSRP procedure with a decision threshold related to the two offset-related parameters.

Example 5 may include the method of example 4, and/or some other example herein, wherein the RedCap UE has a single receive (Rx) antenna.

Example 6 may include the method of any of examples 4-5, and/or some other example herein, wherein an offset-related parameter is offset_{RSRP absolute}.

Example 7 may include the method of any of examples 4-6, and/or some other example herein, wherein an offset-related parameter is offset_{RSRP change}.

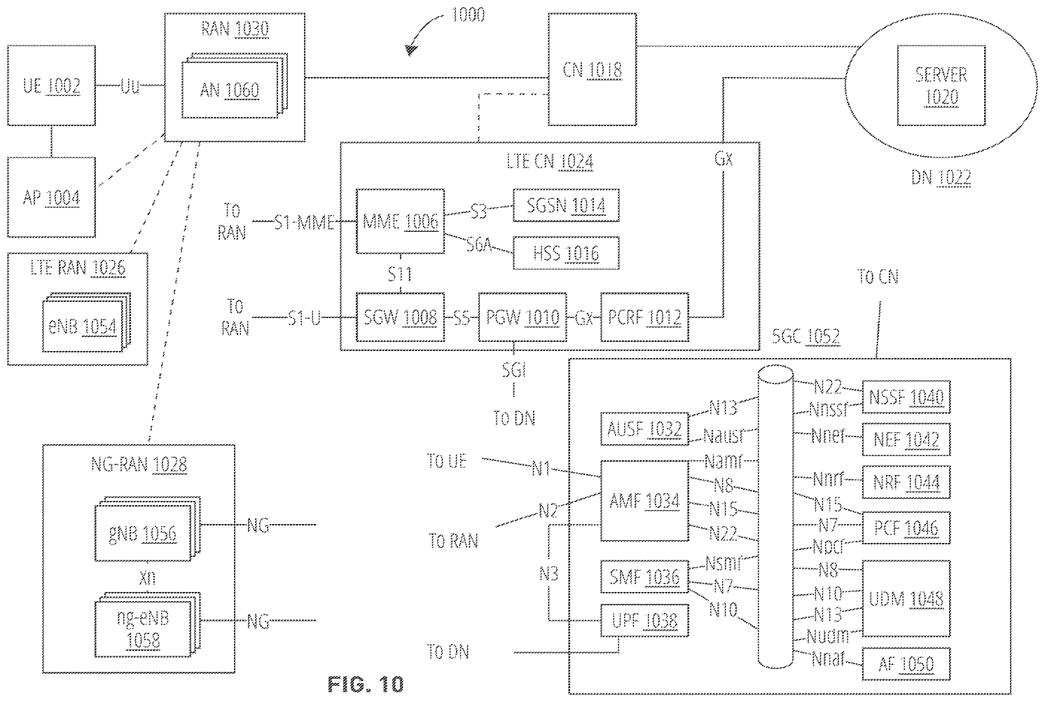

FIGS. 10-14 illustrate various systems, devices and components that may implement aspects of disclosed embodiments. The systems, devices, and components may be the same, or similar to, the systems, device and components described with reference to FIG. 1.

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1030 via an over-the-air connection. The UE 1002 may be communicatively coupled with the RAN 1030 by a Uu interface. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1004 via an over-the-air connection. The AP 1004 may manage a WLAN connection, which may serve to offload some/all network traffic from the RAN 1030. The connection between the UE 1002 and the AP 1004 may be consistent with any IEEE 1002.11 protocol, wherein the AP 1004 could be a wireless fidelity (Wi-Fi®) router. In some embodiments, the UE 1002, RAN 1030, and AP 1004 may utilize cellular-WLAN aggregation (for example, LWA/LWIP). Cellular-WLAN aggregation may involve the UE 1002 being configured by the RAN 1030 to utilize both cellular radio resources and WLAN resources.

The RAN 1030 may include one or more access nodes, for example, AN 1060. AN 1060 may terminate air-interface protocols for the UE 1002 by providing access stratum protocols including RRC, PDCP, RLC, MAC, and L1 protocols. In this manner, the AN 1060 may enable data/voice connectivity between CN 1018 and the UE 1002. In some embodiments, the AN 1060 may be implemented in a discrete device or as one or more software entities running on server computers as part of, for example, a virtual network, which may be referred to as a CRAN or virtual baseband unit pool. The AN 1060 be referred to as a BS, gNB, RAN node, eNB, ng-eNB, NodeB, RSU, TRxP, TRP, etc. The AN 1060 may be a macrocell base station or a low power base station for providing femtocells, picocells or other like cells having smaller coverage areas, smaller user capacity, or higher bandwidth compared to macrocells.

In embodiments in which the RAN 1030 includes a plurality of ANs, they may be coupled with one another via an X2 interface (if the RAN 1030 is an LTE RAN) or an Xn interface (if the RAN 1030 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1030 may each manage one or more cells, cell groups, component carriers, etc. to provide the UE 1002 with an air interface for network access. The UE 1002 may be simultaneously connected with a plurality of cells provided by the same or different ANs of the RAN 1030. For example, the UE 1002 and RAN 1030 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1030 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1060 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally, or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1030 may be an LTE RAN 1026 with eNBs, for example, eNB 1054. The LTE RAN 1026 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 1030 may be an NG-RAN 1028 with gNBs, for example, gNB 1056, or ng-eNBs, for example, ng-eNB 1058. The gNB 1056 may connect with 5G-enabled UEs using a 5G NR interface. The gNB 1056 may connect with a 5G core through an NG interface, which may include an N2 interface or an N3 interface. The ng-eNB 1058 may also connect with the 5G core through an NG interface, but may connect with a UE via an LTE air interface. The gNB 1056 and the ng-eNB 1058 may connect with each other over an Xn interface.

In some embodiments, the NG interface may be split into two parts, an NG user plane (NG-U) interface, which carries traffic data between the nodes of the NG-RAN 1028 and a UPF 1038 (e.g., N3 interface), and an NG control plane (NG-C) interface, which is a signaling interface between the nodes of the NG-RAN 1028 and an AMF 1034 (e.g., N2 interface).

The NG-RAN 1028 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1056. A BWP containing a larger number of PRBs can be used for scenarios with higher traffic load.

The RAN 1030 is communicatively coupled to CN 1018 that includes network elements to provide various functions to support data and telecommunications services to customers/subscribers (for example, users of UE 1002). The components of the CN 1018 may be implemented in one physical node or separate physical nodes. In some embodiments. NFV may be utilized to virtualize any or all of the functions provided by the network elements of the CN 1018 onto physical compute/storage resources in servers, switches, etc. A logical instantiation of the CN 1018 may be referred to as a network slice, and a logical instantiation of a portion of the CN 1018 may be referred to as a network sub-slice.

In some embodiments, the CN 1018 may be an LTE CN 1024, which may also be referred to as an EPC. The LTE CN 1024 may include MME 1006, SGW 1008, SGSN 1014, HSS 1016, PGW 1010, and PCRF 1012 coupled with one another over interfaces (or “reference points”) as shown. Functions of the elements of the LTE CN 1024 may be briefly introduced as follows.

The MME 1006 may implement mobility management functions to track a current location of the UE 1002 to facilitate paging, bearer activation/deactivation, handovers, gateway selection, authentication, etc.

The SGW 1008 may terminate an S1 interface toward the RAN and route data packets between the RAN and the LTE CN 1024. The SGW 1008 may be a local mobility anchor point for inter-RAN node handovers and also may provide an anchor for inter-3GPP mobility. Other responsibilities may include lawful intercept, charging, and some policy enforcement.

The SGSN 1014 may track a location of the UE 1002 and perform security functions and access control. In addition, the SGSN 1014 may perform inter-EPC node signaling for mobility between different RAT networks; PDN and S-GW selection as specified by MME 1006; MME selection for handovers; etc. The S3 reference point between the MME 1006 and the SGSN 1014 may enable user and bearer information exchange for inter-3GPP access network mobility in idle/active states.

The HSS 1016 may include a database for network users, including subscription-related information to support the network entities' handling of communication sessions. The HSS 1016 can provide support for routing/roaming, authentication, authorization, naming/addressing resolution, location dependencies, etc. An S6a reference point between the HSS 1016 and the MME 1006 may enable transfer of subscription and authentication data for authenticating/authorizing user access to the LTE CN 1018.

The PGW 1010 may terminate an SGi interface toward a data network (DN) 1022 that may include an application/content server 1020. The PGW 1010 may route data packets between the LTE CN 1024 and the data network 1022. The PGW 1010 may be coupled with the SGW 1008 by an S5 reference point to facilitate user plane tunneling and tunnel management. The PGW 1010 may further include a node for policy enforcement and charging data collection (for example, PCEF). Additionally, the SGi reference point between the PGW 1010 and the data network 1022 may be an operator external public, a private PDN, or an intra-operator packet data network, for example, for provision of IMS services. The PGW 1010 may be coupled with a PCRF 1012 via a Gx reference point.

The PCRF 1012 is the policy and charging control element of the LTE CN 1024. The PCRF 1012 may be communicatively coupled to the app/content server 1020 to determine appropriate QoS and charging parameters for service flows. The PCRF 1010 may provision associated rules into a PCEF (via Gx reference point) with appropriate TFT and QCI.

In some embodiments, the CN 1018 may be a 5GC 1052. The 5GC 1052 may include an AUSF 1032, AMF 1034, SMF 1036, UPF 1038, NSSF 1040, NEF 1042. NRF 1044, PCF 1046, UDM 1048, and AF 1050 coupled with one another over interfaces (or “reference points”) as shown. Functions of the elements of the 5GC 1052 may be briefly introduced as follows.

The AUSF 1032 may store data for authentication of UE 1002 and handle authentication-related functionality. The AUSF 1032 may facilitate a common authentication framework for various access types. In addition to communicating with other elements of the 5GC 1052 over reference points as shown, the AUSF 1032 may exhibit an Nausf service-based interface.

The AMF 1034 may allow other functions of the 5GC 1052 to communicate with the UE 1002 and the RAN 1030 and to subscribe to notifications about mobility events with respect to the UE 1002. The AMF 1034 may be responsible for registration management (for example, for registering UE 1002), connection management, reachability management, mobility management, lawful interception of AMF-related events, and access authentication and authorization. The AMF 1034 may provide transport for SM messages between the UE 1002 and the SMF 1036, and act as a transparent proxy for routing SM messages. AMF 1034 may also provide transport for SMS messages between UE 1002 and an SMSF. AMF 1034 may interact with the AUSF 1032 and the UE 1002 to perform various security anchor and context management functions. Furthermore, AMF 1034 may be a termination point of a RAN CP interface, which may include or be an N2 reference point between the RAN 1030 and the AMF 1034; and the AMF 1034 may be a termination point of NAS (N1) signaling, and perform NAS ciphering and integrity protection. AMF 1034 may also support NAS signaling with the UE 1002 over an N3 IWF interface.

The SMF 1036 may be responsible for SM (for example, session establishment, tunnel management between UPF 1038 and AN 1060); UE IP address allocation and management (including optional authorization); selection and control of UP function; configuring traffic steering at UPF 1038 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1034 over N2 to AN 1060; and determining SSC mode of a session. SM may refer to management of a PDU session, and a PDU session or “session” may refer to a PDU connectivity service that provides or enables the exchange of PDUs between the UE 1002 and the data network 1022.

The UPF 1038 may act as an anchor point for intra-RAT and inter-RAT mobility, an external PDU session point of interconnect to data network 1022, and a branching point to support multi-homed PDU session. The UPF 1038 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1038 may include an uplink classifier to support routing traffic flows to a data network.

The NSSF 1040 may select a set of network slice instances serving the UE 1002. The NSSF 1040 may also determine allowed NSSAI and the mapping to the subscribed S-NSSAIs, if needed. The NSSF 1040 may also determine the AMF set to be used to serve the UE 1002, or a list of candidate AMFs based on a suitable configuration and possibly by querying the NRF 1044. The selection of a set of network slice instances for the UE 1002 may be triggered by the AMF 1034 with which the UE 1002 is registered by interacting with the NSSF 1040, which may lead to a change of AMF. The NSSF 1040 may interact with the AMF 1034 via an N22 reference point; and may communicate with another NSSF in a visited network via an N31 reference point (not shown). Additionally, the NSSF 1040 may exhibit an Nnssf service-based interface.

The NEF 1042 may securely expose services and capabilities provided by 3GPP network functions for third party, internal exposure/re-exposure, AFs (e.g., AF 1050), edge computing or fog computing systems, etc. In such embodiments, the NEF 1042 may authenticate, authorize, or throttle the AFs. NEF 1042 may also translate information exchanged with the AF 1050 and information exchanged with internal network functions. For example, the NEF 1042 may translate between an AF-Service-Identifier and an internal 5GC information. NEF 1042 may also receive information from other NFs based on exposed capabilities of other NFs. This information may be stored at the NEF 1042 as structured data, or at a data storage NF using standardized interfaces. The stored information can then be re-exposed by the NEF 1042 to other NFs and AFs, or used for other purposes such as analytics. Additionally, the NEF 1042 may exhibit an Nnef service-based interface.

The NRF 1044 may support service discovery functions, receive NF discovery requests from NF instances, and provide the information of the discovered NF instances to the NF instances. NRF 1044 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally. the NRF 1044 may exhibit the Nnrf service-based interface.

The PCF 1046 may provide policy rules to control plane functions to enforce them, and may also support unified policy framework to govern network behavior. The PCF 1046 may also implement a front end to access subscription information relevant for policy decisions in a UDR of the UDM 1048. In addition to communicating with functions over reference points as shown, the PCF 1046 exhibit an Npcf service-based interface.

The UDM 1048 may handle subscription-related information to support the network entities' handling of communication sessions, and may store subscription data of UE 1002. For example, subscription data may be communicated via an N8 reference point between the UDM 1048 and the AMF 1034. The UDM 1048 may include two parts, an application front end and a UDR. The UDR may store subscription data and policy data for the UDM 1048 and the PCF 1046, and/or structured data for exposure and application data (including PFDs for application detection, application request information for multiple UEs 1002) for the NEF 1042. The Nudr service-based interface may be exhibited by the UDR 221 to allow the UDM 1048, PCF 1046, and NEF 1042 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1048 may exhibit the Nudm service-based interface.

The AF 1050 may provide application influence on traffic routing, provide access to NEF, and interact with the policy framework for policy control.

In some embodiments, the 5GC 1052 may enable edge computing by selecting operator/3^{rd} party services to be geographically close to a point that the UE 1002 is attached to the network. This may reduce latency and load on the network. To provide edge-computing implementations, the 5GC 1052 may select a UPF 1038 close to the UE 1002 and execute traffic steering from the UPF 1038 to data network 1022 via the N6 interface. This may be based on the UE subscription data. UE location, and information provided by the AF 1050. In this way, the AF 1050 may influence UPF (re)selection and traffic routing. Based on operator deployment, when AF 1050 is considered to be a trusted entity, the network operator may permit AF 1050 to interact directly with relevant NFs. Additionally, the AF 1050 may exhibit a Naf service-based interface.

The data network 1022 may represent various network operator services, Internet access, or third party services that may be provided by one or more servers including, for example, application/content server 1020.

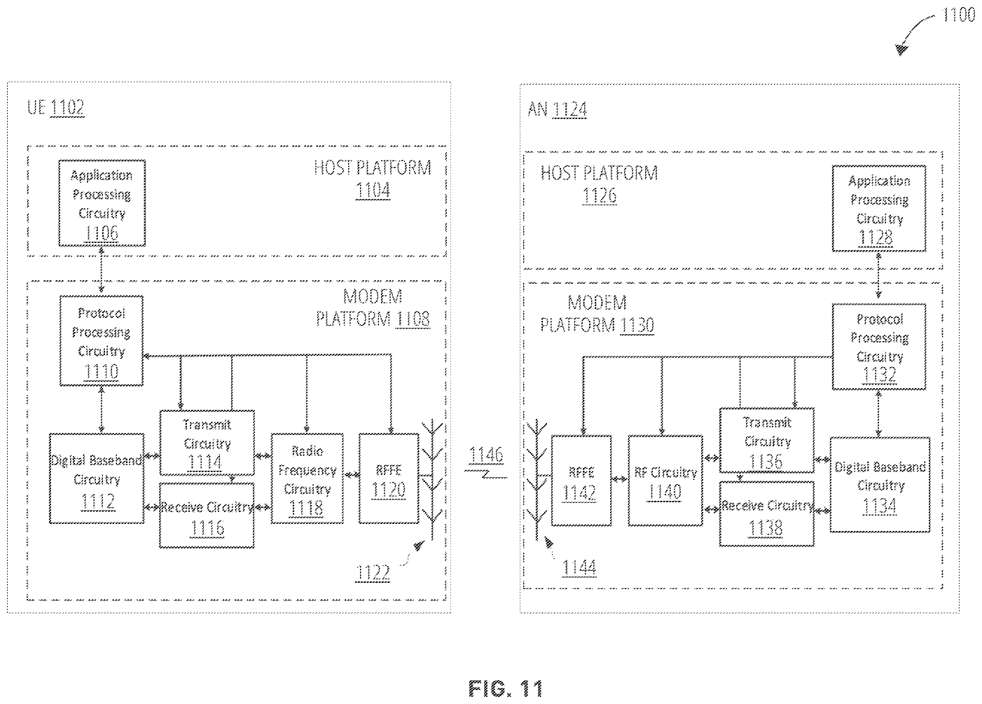

FIG. 11 schematically illustrates a wireless network 1100 in accordance with various embodiments. The wireless network 1100 may include a UE 1102 in wireless communication with an AN 1124. The UE 1102 and AN 1124 may be similar to, and substantially interchangeable with, like-named components described elsewhere herein.

The UE 1102 may be communicatively coupled with the AN 1124 via connection 1146. The connection 1146 is illustrated as an air interface to enable communicative coupling, and can be consistent with cellular communications protocols such as an LTE protocol or a 5G NR protocol operating at mmWave or sub-6GHz frequencies.

The UE 1102 may include a host platform 1104 coupled with a modem platform 1108. The host platform 1104 may include application processing circuitry 1106, which may be coupled with protocol processing circuitry 1110 of the modem platform 1108. The application processing circuitry 1106 may run various applications for the UE 1102 that source/sink application data. The application processing circuitry 1106 may further implement one or more layer operations to transmit/receive application data to/from a data network. These layer operations may include transport (for example UDP) and Internet (for example, IP) operations

The protocol processing circuitry 1110 may implement one or more of layer operations to facilitate transmission or reception of data over the connection 1146. The layer operations implemented by the protocol processing circuitry 1110 may include, for example, MAC, RLC, PDCP, RRC and NAS operations.

The modem platform 1108 may further include digital baseband circuitry 1112 that may implement one or more layer operations that are “below” layer operations performed by the protocol processing circuitry 1110 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1108 may further include transmit circuitry 1114, receive circuitry 1116, RF circuitry 1118, and RF front end (RFFE) 1120, which may include or connect to one or more antenna panels 1122. Briefly, the transmit circuitry 1114 may include a digital-to-analog converter, mixer, intermediate frequency (IF) components, etc.; the receive circuitry 1116 may include an analog-to-digital converter, mixer, IF components, etc.; the RF circuitry 1118 may include a low-noise amplifier, a power amplifier, power tracking components, etc.; RFFE 1120 may include filters (for example, surface/bulk acoustic wave filters), switches, antenna tuners, beamforming components (for example, phase-array antenna components), etc. The selection and arrangement of the components of the transmit circuitry 1114, receive circuitry 1116, RF circuitry 1118, RFFE 1120, and antenna panels 1122 (referred generically as “transmit/receive components”) may be specific to details of a specific implementation such as, for example, whether communication is TDM or FDM, in mmWave or sub-6 gigahertz (gHz) frequencies, etc. In some embodiments, the transmit/receive components may be arranged in multiple parallel transmit/receive chains, may be disposed in the same or different chips/modules, etc.

In some embodiments, the protocol processing circuitry 1110 may include one or more instances of control circuitry (not shown) to provide control functions for the transmit/receive components.

A UE reception may be established by and via the antenna panels 1122, RFFE 1120, RF circuitry 1118, receive circuitry 1116, digital baseband circuitry 1112, and protocol processing circuitry 1110. In some embodiments, the antenna panels 1122 may receive a transmission from the AN 1124 by receive-beamforming signals received by a plurality of antennas/antenna elements of the one or more antenna panels 1122.

A UE transmission may be established by and via the protocol processing circuitry 1110, digital baseband circuitry 1112, transmit circuitry 1114, RF circuitry 1118, RFFE 1120, and antenna panels 1122. In some embodiments, the transmit components of the UE 1124 may apply a spatial filter to the data to be transmitted to form a transmit beam emitted by the antenna elements of the antenna panels 1122.

Similar to the UE 1102, the AN 1124 may include a host platform 1126 coupled with a modem platform 1130. The host platform 1126 may include application processing circuitry 1128 coupled with protocol processing circuitry 1132 of the modem platform 1130. The modem platform may further include digital baseband circuitry 1134, transmit circuitry 1136, receive circuitry 1138, RF circuitry 1140, RFFE circuitry 1142, and antenna panels 1144. The components of the AN 1124 may be similar to and substantially interchangeable with like-named components of the UE 1102. In addition to performing data transmission/reception as described above, the components of the AN 1104 may perform various logical functions that include, for example, RNC functions such as radio bearer management, uplink and downlink dynamic radio resource management, and data packet scheduling.

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1230 including one or more processors (or processor cores) 1210, one or more memory/storage devices 1222, and one or more communication resources 1226, each of which may be communicatively coupled via a bus 1220 or other interface circuitry. For embodiments where node virtualization (e.g., NFV) is utilized, a hypervisor 1202 may be executed to provide an execution environment for one or more network slices/sub-slices to utilize the hardware resources 1230.

The processors 1210 may include, for example, a processor 1212 and a processor 1214. The processors 1210 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1222 may include main memory, disk storage, or any suitable combination thereof. The memory/storage devices 1222 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1226 may include interconnection or network interface controllers, components, or other suitable devices to communicate with one or more peripheral devices 1204 or one or more databases 1206 or other network elements via a network 1208. For example, the communication resources 1226 may include wired communication components (e.g., for coupling via USB, Ethernet, etc.), cellular communication components, NFC components, Bluetooth® (or Bluetooth® Low Energy) components, Wi-Fi® components, and other communication components.

Instructions 106, 1218, 1224, 1228, 1232 may comprise software, a program, an application, an applet, an app, or other executable code for causing at least any of the processors 1210 to perform any one or more of the methodologies discussed herein. The instructions 106, 1218, 1224, 1228, 1232 may reside, completely or partially, within at least one of the processors 1210 (e.g., within the processor's cache memory), the memory/storage devices 1222, or any suitable combination thereof. Furthermore, any portion of the instructions 106, 1218, 1224, 1228, 1232 may be transferred to the hardware resources 1230 from any combination of the peripheral devices 1204 or the databases 1206. Accordingly, the memory of processors 1210, the memory/storage devices 1222, the peripheral devices 1204, and the databases 1206 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

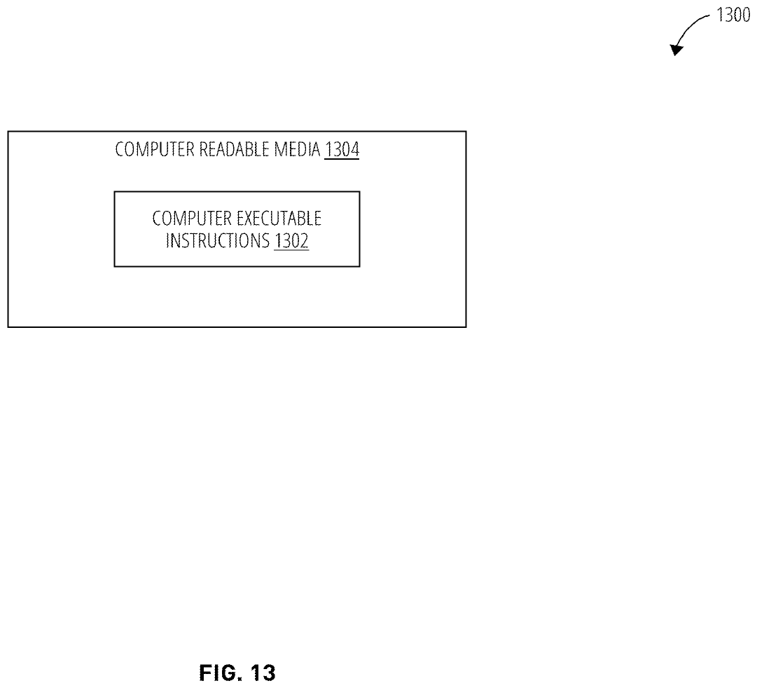

FIG. 13 illustrates computer readable storage medium 1300. Computer readable storage medium 1700 may comprise any non-transitory computer-readable storage medium or machine-readable storage medium, such as an optical, magnetic or semiconductor storage medium. In various embodiments, computer readable storage medium 1300 may comprise an article of manufacture. In some embodiments, computer readable storage medium 1300 may store computer executable instructions 1302 with which circuitry can execute. For example, computer executable instructions 1302 can include computer executable instructions 1302 to implement operations described with respect to logic flow 500, logic flow 700, logic flow 800 and logic flow 900. Examples of computer readable storage medium 1300 or machine-readable storage medium 1300 may include any tangible media capable of storing electronic data, including volatile memory or non-volatile memory, removable or non-removable memory, erasable or non-erasable memory, writeable or re-writeable memory, and so forth. Examples of computer executable instructions 1302 may include any suitable type of code, such as source code, compiled code, interpreted code, executable code, static code, dynamic code, object-oriented code, visual code, and the like.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-13 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media. removable memory cards or disks, various types of Digital Versatile Disk (DVD), a tape, a cassette, or the like. The instructions may include any suitable type of code, such as source code, compiled code, interpreted code, executable code, static code, dynamic code. encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

### EXAMPLES

In one example, an apparatus for user equipment, includes a memory interface to send or receive, to or from a data storage device, measurement information for a fifth generation new radio (5G NR) system. The apparatus for user equipment also includes processor circuitry communicatively coupled to the memory interface, the processor circuitry to perform measurements of a reference signal from a base station of a cell by user equipment (UE) with reduced capability (RedCap) to obtain a measurement value, the UE with RedCap to have a single receive (1 Rx) antenna, retrieve a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna, and evaluate the measurement value in accordance with the relaxed measurement criterion for RedCap to obtain a measurement result.

The apparatus may also include the processor circuitry to determine whether to select the base station of the cell as a serving cell for the UE with RedCap based on the measurement result.

The apparatus may also include the processor circuitry to determine whether to search for a base station of a neighbor cell of the cell as a serving cell for the UE with RedCap based on the measurement result.

The apparatus may also include the processor circuitry to determine whether to initiate small data transmission (SDT) for the UE with RedCap based on the measurement result.

The apparatus may also include the processor circuitry to perform synchronization signal based reference signal received power (SS-RSRP) measurements or synchronization signal based reference signal received quality (SS-RSRQ) measurements.

The apparatus may also include where the cell is an intra-frequency NR cell, an inter-frequency NR cell, or an inter-radio access technology (RAT) evolved universal terrestrial radio access network (E-UTRAN) cell.

The apparatus may also include where the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

The apparatus may also include where the relaxed measurement criterion uses s-SearchDeltaP-r16 as a signaled value of s-SearchDeltaP-r16−1 dB.

The apparatus may also include where the relaxed measurement criterion uses s-SearchDeltaP-Stationary-r17 as s signaled value of s-SearchDeltaP-Stationary-r17−1 dB.

The apparatus may also include where the relaxed measurement criterion uses s-SearchThresholdP-r16 as the signaled value of s-SearchThresholdP-r16+1 dB.

The apparatus may also include where the relaxed measurement criterion uses s-SearchThresholdQ-r16 as the signaled value of s-Search ThresholdQ-r16+1 dB.

The apparatus may also include where the relaxed measurement criterion uses s-SearchThresholdP2-r17 as the signaled value of s-SearchThresholdP2-r17+1 dB.

The apparatus may also include where the relaxed measurement criterion uses s-SearchThresholdQ2-r17 as the signaled value of s-SearchThresholdQ2-r17+1 dB.

The apparatus may also include where the UE with RedCap is in a radio resource control (RRC) idle state, an RRC inactive state, or an RRC connected state.

The apparatus may also include the processor circuitry to retrieve the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

The apparatus may also include radio frequency (RF) circuitry communicatively coupled to the processor circuitry, the RF circuitry to receive RF signals representing the reference signal from the base station. Other technical features may be readily apparent to one skilled in the art from the following figures, descriptions, and claims.

In one example, a method for user equipment, includes performing measurements of a reference signal from a base station of a cell by user equipment (UE) with reduced capability (RedCap) to obtain a measurement value, the UE with RedCap to have a single receive (1 Rx) antenna, retrieving a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna, and evaluating the measurement value in accordance with the relaxed measurement criterion for RedCap to obtain a measurement result.

The method may also include determining whether to select the base station of the cell as a serving cell for the UE with RedCap based on the measurement result.

The method may also include determining whether to search for a base station of a neighbor cell of the cell as a serving cell for the UE with RedCap based on the measurement result.

The method may also include determining whether to initiate small data transmission (SDT) for the UE with RedCap based on the measurement result.

The method may also include performing synchronization signal based reference signal received power (SS-RSRP) measurements or synchronization signal based reference signal received quality (SS-RSRQ) measurements.

The method may also include where the cell is an intra-frequency NR cell, an inter-frequency NR cell, or an inter-radio access technology (RAT) evolved universal terrestrial radio access network (E-UTRAN) cell.

The method may also include where the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

The method may also include where the relaxed measurement criterion uses s-SearchDeltaP-r16 as a signaled value of s-SearchDeltaP-r16−1 dB.

The method may also include where the relaxed measurement criterion uses s-SearchDeltaP-Stationary-r17 as s signaled value of s-SearchDeltaP-Stationary-r17−1 dB.

The method may also include where the relaxed measurement criterion uses s-SearchThresholdP-r16 as the signaled value of s-SearchThresholdP-r16+1 dB.

The method may also include where the relaxed measurement criterion uses s-SearchThresholdQ-r16 as the signaled value of s-SearchThresholdQ-r16+1 dB.

The method may also include where the relaxed measurement criterion uses s-SearchThresholdP2-r17 as the signaled value of s-SearchThresholdP2-r17+1 dB.

The method may also include where the relaxed measurement criterion uses s-SearchThresholdQ2-r17 as the signaled value of s-SearchThresholdQ2-r17+1 dB.

The method may also include where the UE with RedCap is in a radio resource control (RRC) idle state, an RRC inactive state, or an RRC connected state.

The method may also include retrieving the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

The method may also include receiving radio-frequency (RF) signals representing the reference signal from the base station. Other technical features may be readily apparent to one skilled in the art from the following figures, descriptions, and claims.

In one example, a non-transitory computer-readable storage medium, the computer-readable storage medium including instructions that when executed by a computer, cause the computer to perform measurements of a reference signal from a base station of a cell by user equipment (UE) with reduced capability (RedCap) to obtain a measurement value, the UE with RedCap to have a single receive (1 Rx) antenna, retrieve a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna, and evaluate the measurement value in accordance with the relaxed measurement criterion for RedCap to obtain a measurement result.

The computer-readable storage medium may also include instructions to determine whether to select the base station of the cell as a serving cell for the UE with RedCap based on the measurement result.

The computer-readable storage medium may also include instructions to determine whether to search for a base station of a neighbor cell of the cell as a serving cell for the UE with RedCap based on the measurement result.

The computer-readable storage medium may also include instructions to initiate small data transmission (SDT) for the UE with RedCap based on the measurement result.

The computer-readable storage medium may also include instructions to perform synchronization signal based reference signal received power (SS-RSRP) measurements or synchronization signal based reference signal received quality (SS-RSRQ) measurements.

The computer-readable storage medium may also include where the cell is an intra-frequency NR cell, an inter-frequency NR cell, or an inter-radio access technology (RAT) evolved universal terrestrial radio access network (E-UTRAN) cell.

The computer-readable storage medium may also include where the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

The computer-readable storage medium may also include where the relaxed measurement criterion uses s-SearchDeltaP-r16 as a signaled value of s-SearchDeltaP-r16−1 dB.

The computer-readable storage medium may also include where the relaxed measurement criterion uses s-SearchDeltaP-Stationary-r17 as s signaled value of s-SearchDeltaP-Stationary-r17−1 dB.

The computer-readable storage medium may also include where the relaxed measurement criterion uses s-SearchThresholdP-r16 as the signaled value of s-SearchThresholdP-r16+1 dB.

The computer-readable storage medium may also include where the relaxed measurement criterion uses s-SearchThresholdQ-r16 as the signaled value of s-SearchThresholdQ-r16+1 dB.

The computer-readable storage medium may also include where the relaxed measurement criterion uses s-SearchThresholdP2-r17 as the signaled value of s-SearchThresholdP2-r17+1 dB.

The computer-readable storage medium may also include where the relaxed measurement criterion uses s-SearchThresholdQ2-r17 as the signaled value of s-SearchThresholdQ2-r17+1 dB.

The computer-readable storage medium may also include where the UE with RedCap is in a radio resource control (RRC) idle state, an RRC inactive state, or an RRC connected state.

The computer-readable storage medium may also include instructions to retrieve the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

The computer-readable storage medium may also include instructions to receive radio-frequency (RF) signals representing the reference signal from the base station. Other technical features may be readily apparent to one skilled in the art from the following figures, descriptions, and claims.

In one example, an apparatus for user equipment, includes means for sending or receiving, to or from a data storage device, measurement information for a fifth generation new radio (5G NR) system, and means for performing measurements of a reference signal from a base station of a cell by user equipment (UE) with reduced capability (RedCap) to obtain a measurement value, the UE with RedCap to have a single receive (1 Rx) antenna. The apparatus for user equipment also includes means for retrieving a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna. The apparatus for user equipment also includes means for evaluating the measurement value in accordance with the relaxed measurement criterion for RedCap to obtain a measurement result.

The apparatus may also include means for determining whether to select the base station of the cell as a serving cell for the UE with RedCap based on the measurement result.

The apparatus may also include means for determining whether to search for a base station of a neighbor cell of the cell as a serving cell for the UE with RedCap based on the measurement result.

The apparatus may also include means for determining whether to initiate small data transmission (SDT) for the UE with RedCap based on the measurement result.

The apparatus may also include means for performing synchronization signal based reference signal received power (SS-RSRP) measurements or synchronization signal based reference signal received quality (SS-RSRQ) measurements.

The apparatus may also include where the cell is an intra-frequency NR cell, an inter-frequency NR cell, or an inter-radio access technology (RAT) evolved universal terrestrial radio access network (E-UTRAN) cell.

The apparatus may also include where the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

The apparatus may also include where the relaxed measurement criterion uses s-SearchDeltaP-r16 as a signaled value of s-SearchDeltaP-r16−1 dB.

The apparatus may also include where the relaxed measurement criterion uses s-SearchDeltaP-Stationary-r17 as s signaled value of s-SearchDeltaP-Stationary-r17−1 dB.

The apparatus may also include where the relaxed measurement criterion uses s-SearchThresholdP-r16 as the signaled value of s-SearchThresholdP-r16+1 dB.

The apparatus may also include where the relaxed measurement criterion uses s-SearchThresholdQ-r16 as the signaled value of s-Search ThresholdQ-r16+1 dB.

The apparatus may also include where the relaxed measurement criterion uses s-SearchThresholdP2-r17 as the signaled value of s-SearchThresholdP2-r17+1 dB.

The apparatus may also include where the relaxed measurement criterion uses s-SearchThresholdQ2-r17 as the signaled value of s-SearchThresholdQ2-r17+1 dB.

The apparatus may also include where the UE with RedCap is in a radio resource control (RRC) idle state, an RRC inactive state, or an RRC connected state.

The apparatus may also include means for retrieving the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

The apparatus may also include means for receiving radio-frequency (RF) signals representing the reference signal from the base station.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to providing a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1-20. (canceled)

21. An apparatus for user equipment, comprising:
a memory interface to send or receive, to or from a data storage device, measurement information for a fifth generation new radio (5G NR) system; and
processor circuitry communicatively coupled to the memory interface, the processor circuitry to:
decode measurements of a reference signal of a cell by user equipment (UE) with reduced capability (RedCap) to obtain a measurement value, the UE with RedCap to have a single receive (1 Rx) antenna;
retrieve a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna; and
evaluate the measurement value in accordance with the relaxed measurement criterion for RedCap to obtain a measurement result.

22. The apparatus of claim 21, the processor circuitry to:
determine whether to select a base station of the cell as a serving cell for the UE with RedCap based on the measurement result; or
determine whether to search for a base station of a neighbor cell of the cell as a serving cell for the UE with RedCap based on the measurement result.

23. The apparatus of claim 21, the processor circuitry to perform synchronization signal based reference signal received power (SS-RSRP) measurements or synchronization signal based reference signal received quality (SS-RSRQ) measurements.

24. The apparatus of claim 21, wherein the cell is an intra-frequency NR cell, an inter-frequency NR cell, or an inter-radio access technology (RAT) evolved universal terrestrial radio access network (E-UTRAN) cell.

25. The apparatus of claim 21, wherein the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

26. The apparatus of claim 21, wherein the relaxed measurement criterion uses:
s-SearchDeltaP-r16 as a signaled value of s-SearchDeltaP-r16−1 decibel (dB);
s-SearchDeltaP-Stationary-r17 as s signaled value of s-SearchDeltaP-Stationary-r17−1 dB;
s-Search ThresholdP-r16 as the signaled value of s-Search ThresholdP-r16+1 dB;
s-Search ThresholdQ-r16 as the signaled value of s-Search ThresholdQ-r16+1 dB;
s-Search ThresholdP2-r17 as the signaled value of s-SearchThresholdP2-r17+1 dB; or
s-SearchThresholdQ2-r17 as the signaled value of s-Search ThresholdQ2-r17+1 dB.

27. The apparatus of claim 21, wherein the UE with RedCap is in a radio resource control (RRC) idle state, an RRC inactive state, or an RRC connected state.

28. The apparatus of claim 21, the processor circuitry to retrieve the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

29. The apparatus of claim 21, comprising radio frequency (RF) circuitry communicatively coupled to the processor circuitry, the RF circuitry to receive RF signals representing the reference signal from the base station.

30. A method for user equipment, comprising:
decoding measurements of a reference signal of a cell by user equipment (UE) with reduced capability (RedCap) to obtain a measurement value, the UE with RedCap to have a single receive (1 Rx) antenna;
retrieving a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna; and
evaluating the measurement value in accordance with the relaxed measurement criterion for RedCap to obtain a measurement result.

31. The method of claim 30, comprising determining whether to:
selecting a base station of the cell as a serving cell for the UE with RedCap based on the measurement result; or
searching for a base station of a neighbor cell of the cell as a serving cell for the UE with RedCap based on the measurement result.

32. The method of claim 30, comprising performing synchronization signal based reference signal received power (SS-RSRP) measurements or synchronization signal based reference signal received quality (SS-RSRQ) measurements.

33. The method of claim 30, wherein the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

34. The method of claim 30, wherein the relaxed measurement criterion uses:
s-SearchDeltaP-r16 as a signaled value of s-SearchDeltaP-r16−1 decibel (dB);
s-SearchDeltaP-Stationary-r17 as s signaled value of s-SearchDeltaP-Stationary-r17−1 dB;
s-Search ThresholdP-r16 as the signaled value of s-Search ThresholdP-r16+1 dB;
s-SearchThresholdQ-r16 as the signaled value of s-SearchThresholdQ-r16+1 dB;
s-Search ThresholdP2-r17 as the signaled value of s-Search ThresholdP2-r17+1 dB; or
s-Search ThresholdQ2-r17 as the signaled value of s-Search ThresholdQ2-r17+1 dB.

35. The method of claim 30, comprising retrieving the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.

36. A non-transitory computer-readable storage medium, the computer-readable storage medium including instructions that when executed by a computer, cause the computer to:
decode measurements of a reference signal of a cell by user equipment (UE) with reduced capability (RedCap) to obtain a measurement value, the UE with RedCap to have a single receive (1 Rx) antenna;
retrieve a relaxed measurement criterion from a set of relaxed measurement criteria for RedCap associated with the UE with RedCap, the relaxed measurement criteria to include a 1 Rx offset to define measurement thresholds for the UE with RedCap having the 1 Rx antenna; and
evaluate the measurement value in accordance with the relaxed measurement criterion for RedCap to obtain a measurement result.

37. The computer-readable storage medium of claim 36, comprising instructions to determine whether to:
select a base station of the cell as a serving cell for the UE with RedCap based on the measurement result; or
search for a base station of a neighbor cell of the cell as a serving cell for the UE with RedCap based on the measurement result.

38. The computer-readable storage medium of claim 36, wherein the measurements are measurements of intra-frequency NR cells for the UE configured with the relaxed measurement criterion for RedCap, measurements of inter-frequency NR cells for the UE configured with the relaxed measurement criterion for RedCap, or measurements of inter-radio access technology (RAT) evolved universal terrestrial radio access network (E-UTRAN) cells for the UE configured with the relaxed measurement criterion for RedCap.

39. The computer-readable storage medium of claim 36, wherein the relaxed measurement criterion uses:
s-SearchDeltaP-r16 as a signaled value of s-SearchDeltaP-r16−1 decibel (dB);
s-SearchDeltaP-Stationary-r17 as s signaled value of s-SearchDeltaP-Stationary-r17−1 dB;
s-Search ThresholdP-r16 as the signaled value of s-Search ThresholdP-r16+1 dB;
s-Search ThresholdQ-r16 as the signaled value of s-Search ThresholdQ-r16+1 dB;
s-Search ThresholdP2-r17 as the signaled value of s-SearchThresholdP2-r17+1 dB; or
s-Search ThresholdQ2-r17 as the signaled value of s-Search ThresholdQ2-r17+1 dB.

40. The computer-readable storage medium of claim 36, comprising instructions to retrieve the relaxed measurement criterion from a measurement pool index, the measurement pool index to store relaxed measurement criteria indexed by features, radio resource control (RRC) states, related thresholds, a threshold range, offsets associated with a signal-to-noise (SNR) scheme, or offset pool.
